(19) United States
(12) Patent Application Publication
(10) Pub. No.: US 2020/0359411 A1
(43) Pub. Date: Nov. 12, 2020

(54) METHOD AND APPARATUS FOR UE TO gNB CHANNEL OCCUPANCY TIME SHARING IN NR UNLICENSED

(71) Applicant: Samsung Electronics Co., Ltd., Suwon-si (KR)

(72) Inventors: Yingzhe Li, Mountain View, CA (US); Hongbo Si, Plano, TX (US)

(21) Appl. No.: 16/856,858

(22) Filed: Apr. 23, 2020

Related U.S. Application Data
(60) Provisional application No. 62/846,286, filed on May 10, 2019.
(60) Provisional application No. 62/866,948, filed on Jun. 26, 2019.
(60) Provisional application No. 62/904,281, filed on Sep. 23, 2019.
(60) Provisional application No. 62/906,339, filed on Sep. 26, 2019.

(51) Int. Cl. H04W 74/00; H04W 16/14; H04W 74/08; H04W 72/12

(52) U.S. Cl. CPC H04W 74/006; H04W 16/14; H04W 72/1289; H04W 72/1268; H04W 72/1273; H04W 74/0808

(57) ABSTRACT

A method and apparatus is provided in a wireless communication system supporting a shared spectrum channel access. The method and apparatus comprises: receiving DCI indicating a type of LBT process for an uplink transmission including a PUSCH; performing an LBT process based on the type of the LBT process indicated in the DCI; initializing, during a COT, a channel occupancy comprising a first portion and a second portion that do not overlap each other; transmitting the uplink transmission including the PUSCH in the first portion of the channel occupancy that begins at a starting portion of the channel occupancy; and receiving a downlink transmission in the second portion of the channel occupancy, the downlink transmission comprising at least one of a unicast downlink transmission addressed only to the UE or a non-unicast downlink transmission addressed to a set of UEs including the UE.

### CROSS-REFERENCE TO RELATED APPLICATIONS AND CLAIM OF PRIORITY

The present application claims priority to:
U.S. Provisional Patent Application No. 62/846,286, filed on May 10, 2019;
U.S. Provisional Patent Application No. 62/866,948, filed on Jun. 26, 2019;
U.S. Provisional Patent Application No. 62/904,281, filed on Sep. 23, 2019; and
U.S. Provisional Patent Application No. 62/906,339, filed on Sep. 26, 2019.
   The content of the above-identified patent document is incorporated herein by reference.

### TECHNICAL FIELD

The present application relates generally to wireless communication systems, more specifically, the present disclosure relates to channel occupancy time sharing in NR unlicensed.

### BACKGROUND

A communication system includes a downlink (DL) that conveys signals from transmission points such as base stations (BSs) or NodeBs to user equipments (UEs) and an uplink (UL) that conveys signals from UEs to reception points such as NodeBs. A UE, also commonly referred to as a terminal or a mobile station, may be fixed or mobile and may be a cellular phone, a personal computer device, or an automated device. An eNodeB (eNB), referring to a NodeB in long-term evolution (LTE) communication system, and a gNodeB (gNB), referring to a NodeB in new radio (NR) communication system, may also be referred to as an access point or other equivalent terminology.

### SUMMARY

The present disclosure relates to a pre-5G or 5G communication system to be provided for a channel occupancy time sharing in NR.

In one embodiment, a user equipment (UE) in a wireless communication system supporting a shared spectrum channel access is provided. Th UE comprises a transceiver configured to receive, from a base station (BS), downlink control information (DCI) indicating a type of listen-before-talk (LBT) process for an uplink transmission including a physical uplink shared channel (PUSCH). The UE further comprises a processor operably connected to the transceiver, the processor configured to perform an LBT process based on the type of the LBT process indicated in the DCI, and initialize, during a channel occupancy time (COT), a channel occupancy comprising a first portion and a second portion that do not overlap each other. The UE comprises the transceiver further configured to transmit, to the BS, the uplink transmission including the PUSCH in the first portion of the channel occupancy that begins at a starting portion of the channel occupancy and receive, from the BS, a downlink transmission in the second portion of the channel occupancy, the downlink transmission comprising at least one of a unicast downlink transmission addressed only to the UE or a non-unicast downlink transmission addressed to a set of UEs including the UE.

In another embodiment, a base station (BS) in a wireless communication system supporting a shared spectrum channel access is provided. The BS comprises a processor. The BS further comprises a transceiver operably connected to the processor, the transceiver configured to transmit, to a user equipment (UE), downlink control information (DCI) indicating a type of listen-before-talk (LBT) process for an uplink transmission including a physical uplink shared channel (PUSCH), receive, from the UE, the uplink transmission including the PUSCH in a first portion of a channel occupancy that begins at a starting portion of the channel occupancy, transmit, to the UE, a downlink transmission in a second portion of the channel occupancy, the downlink transmission comprising at least one of a unicast downlink transmission addressed only to the UE or a non-unicast downlink transmission addressed to a set of UEs including the UE. An LBT process of the UE is performed based on the type of the LBT process indicated in the DCI, and a channel occupancy is initialized by the UE during a channel occupancy time (COT), the channel occupancy comprising the first portion and the second portion that do not overlap each other.

In yet another embodiment, a method of a user equipment (UE) in a wireless communication system supporting a shared spectrum channel access is provided. The method comprises: receiving, from a base station (BS), downlink control information (DCI) indicating a type of listen-before-talk (LBT) process for an uplink transmission including a physical uplink shared channel (PUSCH); performing an LBT process based on the type of the LBT process indicated in the DCI; initializing, during a channel occupancy time (COT), a channel occupancy comprising a first portion and a second portion that do not overlap each other; transmitting, to the BS, the uplink transmission including the PUSCH in the first portion of the channel occupancy that begins at a starting portion of the channel occupancy; and receiving, from the BS, a downlink transmission in the second portion of the channel occupancy, the downlink transmission comprising at least one of a unicast downlink transmission addressed only to the UE or a non-unicast downlink transmission addressed to a set of UEs including the UE.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example transmitter structure using OFDM according to embodiments of the present disclosure;

FIG. 5 illustrates an example receiver structure using OFDM according to embodiments of the present disclosure;

FIG. 6 illustrates an example encoding process for a DCI format according to embodiments of the present disclosure;

FIG. 7 illustrates an example decoding process for a DCI format for use with a UE according to embodiments of the present disclosure;

FIG. 8 illustrates an example channel access procedure according to embodiments of the present disclosure;

FIG. 9 illustrates an example UL transmission according to embodiments of the present disclosure;

FIG. 10A illustrates another example UL transmission according to embodiments of the present disclosure;

FIG. 10B illustrates yet another example UL transmission according to embodiments of the present disclosure;

FIG. 10C illustrates yet another example UL transmission according to embodiments of the present disclosure;

FIG. 11 illustrates an example intended UL transmission according to embodiments of the present disclosure;

FIG. 12 illustrates an example UL transmission with constraint according to embodiments of the present disclosure;

FIG. 13 illustrates an example UL transmission according to embodiments of the present disclosure;

FIG. 14 illustrates an example UL transmission for two LBT bandwidth according to embodiments of the present disclosure;

FIG. 15 illustrates another example UL transmission for two LBT bandwidth according to embodiments of the present disclosure;

FIG. 16 illustrates yet another example UL transmission for two LBT bandwidth according to embodiments of the present disclosure;

FIG. 17A illustrates an example CAT-2 LBT according to embodiments of the present disclosure;

FIG. 17B illustrates another example CAT-2 LBT according to embodiments of the present disclosure;

FIG. 17C illustrates yet another example CAT-2 LBT according to embodiments of the present disclosure;

FIG. 17D illustrates yet another example CAT-2 LBT according to embodiments of the present disclosure;

FIG. 17E illustrates yet another example CAT-2 LBT according to embodiments of the present disclosure;

FIG. 17F illustrates yet another example CAT-2 LBT according to embodiments of the present disclosure;

FIG. 18 illustrates an example UL transmission with two LBT bandwidth according to embodiments of the present disclosure;

FIG. 19 illustrates another example UL transmission with two LBT bandwidth according to embodiments of the present disclosure;

FIG. 20 illustrates yet another example UL transmission with two LBT bandwidth according to embodiments of the present disclosure;

FIG. 21 illustrates an example indication and signaling for LBT type according to embodiments of the present disclosure;

FIG. 22 illustrates another example indication and signaling for LBT type according to embodiments of the present disclosure;

FIG. 23 illustrates an example gap duration according to embodiments of the present disclosure;

FIG. 24 illustrates another example gap duration according to embodiments of the present disclosure;

FIG. 25 illustrates yet another example gap duration according to embodiments of the present disclosure;

FIG. 26 illustrates an example UL CAT-2 LBT failure according to embodiments of the present disclosure;

FIG. 27 illustrates another example UL CAT-2 LBT failure according to embodiments of the present disclosure;

FIG. 28 illustrates yet another example UL CAT-2 LBT failure according to embodiments of the present disclosure;

FIG. 29 illustrates yet another example UL CAT-2 LBT failure according to embodiments of the present disclosure; and

FIG. 30 illustrates a flow chart of a method for channel occupancy time sharing according to embodiments of the present disclosure.

### DETAILED DESCRIPTION

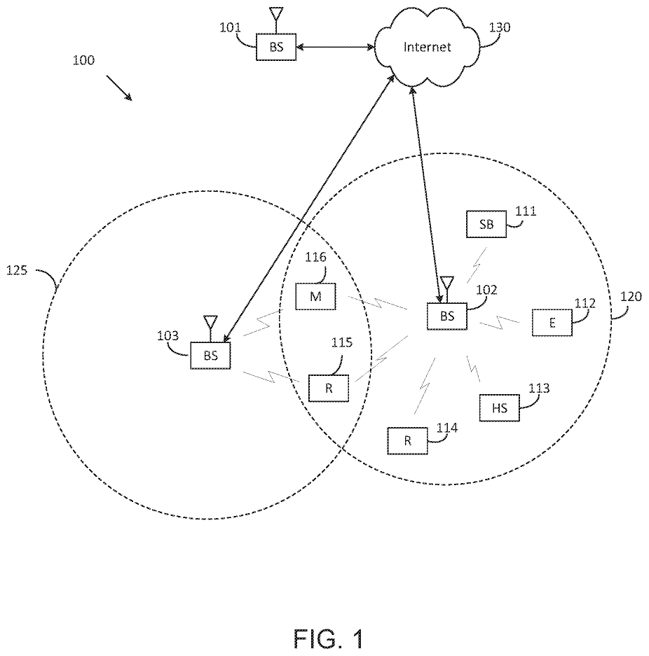

FIG. 1 through FIG. 30, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v15.4.0, “NR; Physical channels and modulation;” 3GPP TS 38.212 v15.4.0, “NR; Multiplexing and Channel coding;” 3GPP TS 38.213 v15.4.0, “NR; Physical Layer Procedures for Control;” 3GPP TS 38.214 v15.4.0, “NR; Physical Layer Procedures for Data;” 3GPP TS 38.331 v15.4.0, “NR; Radio Resource Control (RRC) Protocol Specification;” ETSI EN 301 893 V2.1.1, “5 GHz RLAN; Harmonized Standard covering the essential requirements of article 3.2 of Directive 2014/53/EU”, 2017; ETSI EN 302 567 V2.1.1, “Multiple-Gigabit/s radio equipment operating in the 60 GHz band; Harmonized Standard covering the essential requirements of article 3.2 of Directive 2014/53/EU,” 2017; 3GPP TR 36.889 V13.0.0, “Study on Licensed-Assisted Access to Unlicensed Spectrum,” 2015; and IEEE Std 802.11-2016, “Part 11: Wireless LAN Medium Access Control (MAC) and Physical Layer (PHY) Specifications,” 2016.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, LTE, LTE-A, WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio interface/access (NR), long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programming, or a combination thereof, for reception reliability for data and control information in an advanced wireless communication system. In certain embodiments, and one or more of the gNBs 101-103 includes circuitry, programming, or a combination thereof, for efficient channel occupancy time sharing in NR unlicensed.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

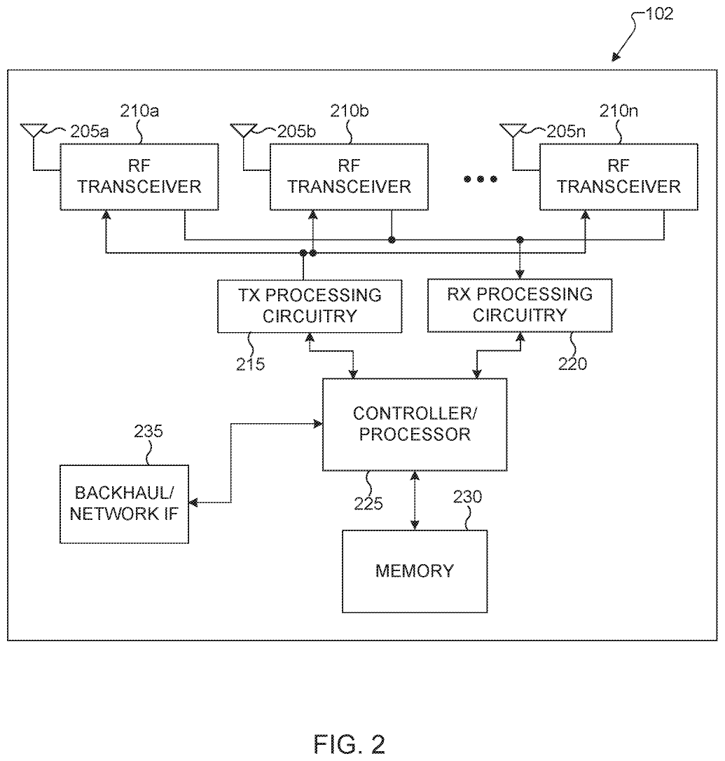

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of forward channel signals and the transmission of reverse channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of the gNB 102, various changes may be made to FIG. 2. For example, the gNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

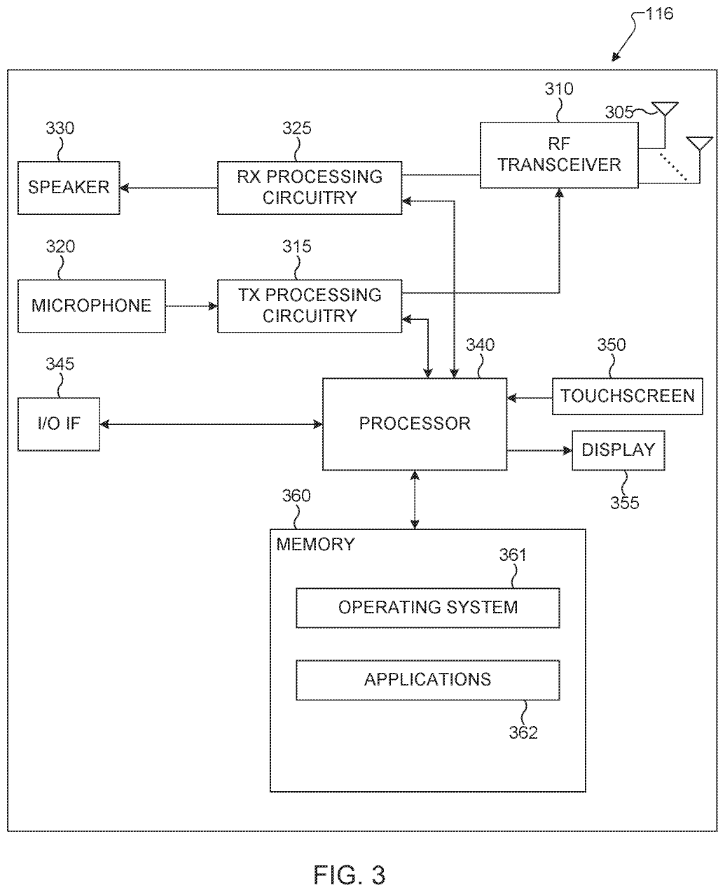

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of forward channel signals and the transmission of reverse channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for beam management. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of the UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

The present disclosure relates generally to wireless communication systems and, more specifically, to reducing power consumption for a user equipment (UE) communicating with a base station and to transmissions to and receptions from a UE of physical downlink control channels (PDCCHs) for operation with dual connectivity. A communication system includes a downlink (DL) that refers to transmissions from a base station or one or more transmission points to UEs and an uplink (UL) that refers to transmissions from UEs to a base station or to one or more reception points.

To meet the demand for wireless data traffic having increased since deployment of 4G communication systems, efforts have been made to develop an improved 5G or pre-5G communication system. Therefore, the 5G or pre-5G communication system is also called a “beyond 4G network” or a “post LTE system.” The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can include 14 symbols, have duration of 1 millisecond or 0.5 milliseconds, and an RB can have a BW of 180 kHz or 360 kHz and include 12 SCs with inter-SC spacing of 15 kHz or 30 kHz, respectively.

DL signals include data signals conveying information content, control signals conveying DL control information (DCI) formats, and reference signals (RS) that are also known as pilot signals. A gNB can transmit data information (e.g., transport blocks) or DCI formats through respective physical DL shared channels (PDSCHs) or physical DL control channels (PDCCHs). A gNB can transmit one or more of multiple types of RS including channel state information RS (CSI-RS) and demodulation RS (DMRS). A CSI-RS is intended for UEs to measure channel state information (CSI) or to perform other measurements such as ones related to mobility support. A DMRS can be transmitted only in the BW of a respective PDCCH or PDSCH and a UE can use the DMRS to demodulate data or control information.

UL signals also include data signals conveying information content, control signals conveying UL control information (UCI), and RS. A UE transmits data information (e.g., transport blocks) or UCI through a respective physical UL shared channel (PUSCH) or a physical UL control channel (PUCCH). When a UE simultaneously transmits data information and UCI, the UE can multiplex both in a PUSCH or transmit them separately in respective PUSCH and PUCCH. UCI includes hybrid automatic repeat request acknowledgement (HARQ-ACK) information, indicating correct or incorrect detection of data transport blocks (TBs) by a UE, scheduling request (SR) indicating whether a UE has data in the UE's buffer, and CSI reports enabling a gNB to select appropriate parameters to perform link adaptation for PDSCH or PDCCH transmissions to a UE.

A CSI report from a UE can include a channel quality indicator (CQI) informing a gNB of a modulation and coding scheme (MCS) for the UE to detect a data TB with a predetermined block error rate (BLER), such as a 10% BLER, of a precoding matrix indicator (PMI) informing a gNB how to precode signaling to a UE, and of a rank indicator (RI) indicating a transmission rank for a PDSCH. UL RS includes DMRS and sounding RS (SRS). DMRS is transmitted only in a BW of a respective PUSCH or PUCCH transmission. A gNB can use a DMRS to demodulate information in a respective PUSCH or PUCCH. SRS is transmitted by a UE to provide a gNB with UL CSI and, for a TDD or a flexible duplex system, to also provide a PMI for DL transmissions. An UL DMRS or SRS transmission can be based, for example, on a transmission of a Zadoff-Chu (ZC) sequence or, in general, of a CAZAC sequence.

DL transmissions and UL transmissions can be based on an orthogonal frequency division multiplexing (OFDM) waveform including a variant using DFT preceding that is known as DFT-spread-OFDM.

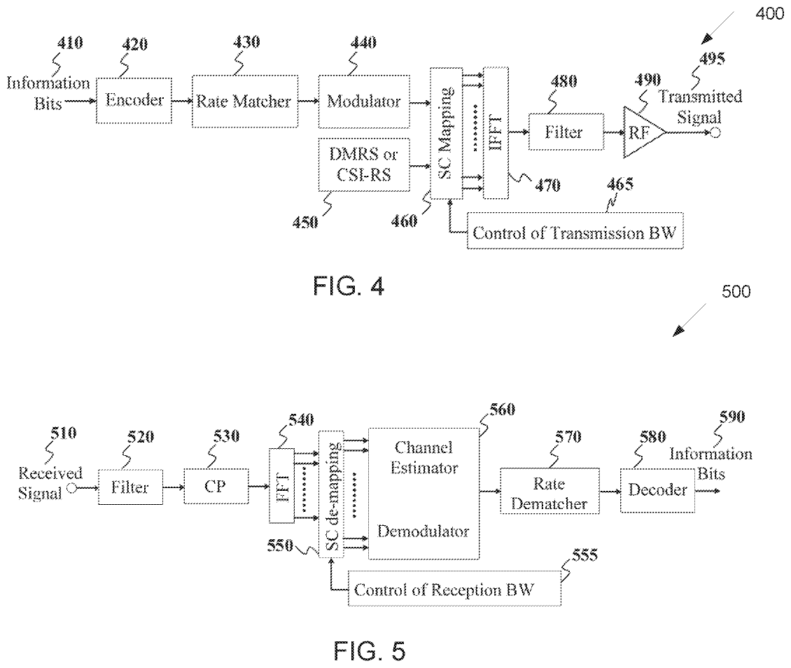

FIG. 4 illustrates an example transmitter structure 400 using OFDM according to embodiments of the present disclosure. An embodiment of the transmitter structure 400 shown in FIG. 4 is for illustration only. One or more of the components illustrated in FIG. 4 can be implemented in specialized circuitry configured to perform the noted functions or one or more of the components can be implemented by one or more processors executing instructions to perform the noted functions. Other embodiments are used without departing from the scope of the present disclosure.

Information bits, such as DCI bits or data bits 410, are encoded by encoder 420, rate matched to assigned time/frequency resources by rate matcher 430 and modulated by modulator 440. Subsequently, modulated encoded symbols and DMRS or CSI-RS 450 are mapped to SCs 460 by SC mapping unit 465, an inverse fast Fourier transform (IFFT) is performed by filter 470, a cyclic prefix (CP) is added by CP insertion unit 480, and a resulting signal is filtered by filter 490 and transmitted by a radio frequency (RF) unit 495.

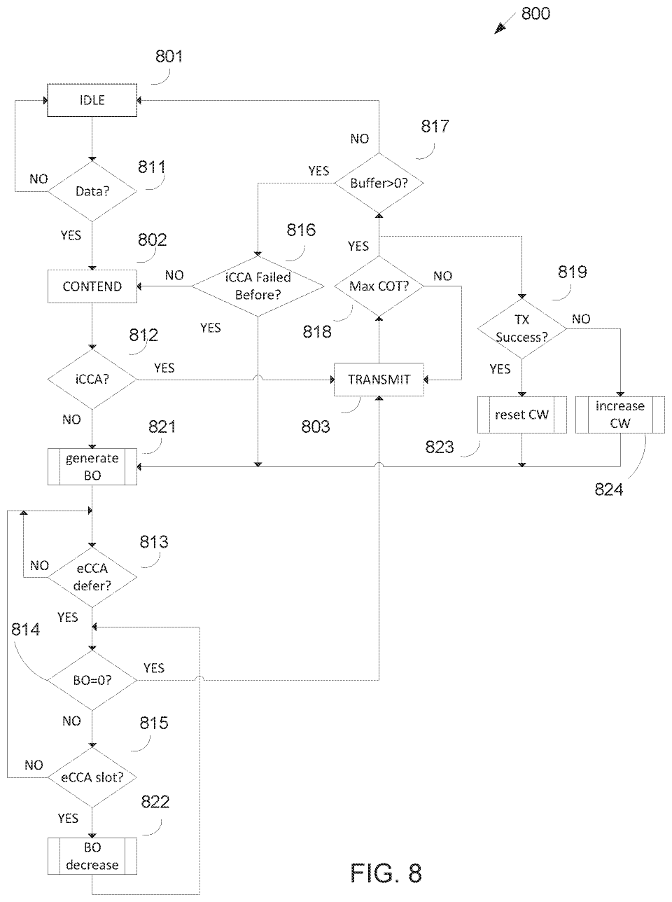

FIG. 5 illustrates an example receiver structure 500 using OFDM according to embodiments of the present disclosure. An embodiment of the receiver structure 500 shown in FIG. 5 is for illustration only. One or more of the components illustrated in FIG. 8 can be implemented in specialized circuitry configured to perform the noted functions or one or more of the components can be implemented by one or more processors executing instructions to perform the noted functions. Other embodiments are used without departing from the scope of the present disclosure.

A received signal 510 is filtered by filter 520, a CP removal unit removes a CP 530, a filter 540 applies a fast Fourier transform (FFT), SCs de-mapping unit 550 de-maps SCs selected by BW selector unit 555, received symbols are demodulated by a channel estimator and a demodulator unit 560, a rate de-matcher 570 restores a rate matching, and a decoder 580 decodes the resulting bits to provide information bits 590.

A UE typically monitors multiple candidate locations for respective potential PDCCH transmissions to decode multiple candidate DCI formats in a slot. Monitoring a PDCCH candidates means receiving and decoding the PDCCH candidate according to DCI formats the UE is configured to receive. A DCI format includes cyclic redundancy check (CRC) bits in order for the UE to confirm a correct detection of the DCI format. A DCI format type is identified by a radio network temporary identifier (RNTI) that scrambles the CRC bits. For a DCI format scheduling a PDSCH or a PUSCH to a single UE, the RNTI can be a cell RNTI (C-RNTI) and serves as a UE identifier.

For a DCI format scheduling a PDSCH conveying system information (SI), the RNTI can be an SI-RNTI. For a DCI format scheduling a PDSCH providing a random-access response (RAR), the RNTI can be an RA-RNTI. For a DCI format scheduling a PDSCH or a PUSCH to a single UE prior to a UE establishing a radio resource control (RRC) connection with a serving gNB, the RNTI can be a temporary C-RNTI (TC-RNTI). For a DCI format providing TPC commands to a group of UEs, the RNTI can be a TPC-PUSCH-RNTI or a TPC-PUCCH-RNTI. Each RNTI type can be configured to a UE through higher layer signaling such as RRC signaling. A DCI format scheduling PDSCH transmission to a UE is also referred to as DL DCI format or DL assignment while a DCI format scheduling PUSCH transmission from a UE is also referred to as UL DCI format or UL grant.

A PDCCH transmission can be within a set of physical RBs (PRBs). A gNB can configure a UE one or more sets of PRBs, also referred to as control resource sets, for PDCCH receptions. A PDCCH transmission can be in control channel elements (CCEs) that are included in a control resource set. A UE determines CCEs for a PDCCH reception based on a search space such as a UE-specific search space (USS) for PDCCH candidates with DCI format having CRC scrambled by a RNTI, such as a C-RNTI, that is configured to the UE by UE-specific RRC signaling for scheduling PDSCH reception or PUSCH transmission, and a common search space (CSS) for PDCCH candidates with DCI formats having CRC scrambled by other RNTIs. A set of CCEs that can be used for PDCCH transmission to a UE define a PDCCH candidate location. A property of a control resource set is transmission configuration indication (TCI) state that provides quasi co-location information of the DMRS antenna port for PDCCH reception.

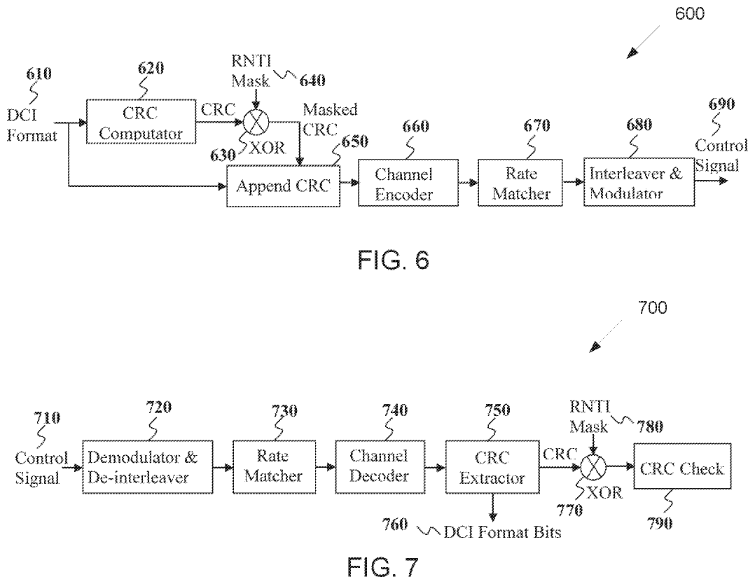

FIG. 6 illustrates an example encoding process 600 for a DCI format according to embodiments of the present disclosure. An embodiment of the encoding process 600 shown in FIG. 6 is for illustration only. One or more of the components illustrated in FIG. 6 can be implemented in specialized circuitry configured to perform the noted functions or one or more of the components can be implemented by one or more processors executing instructions to perform the noted functions. Other embodiments are used without departing from the scope of the present disclosure.

A gNB separately encodes and transmits each DCI format in a respective PDCCH. A RNTI masks a CRC of the DCI format codeword in order to enable the UE to identify the DCI format. For example, the CRC and the RNTI can include, for example, 16 bits or 24 bits. The CRC of (non-coded) DCI format bits 610 is determined using a CRC computation unit 620, and the CRC is masked using an exclusive OR (XOR) operation unit 630 between CRC bits and RNTI bits 640. The XOR operation is defined as XOR (0, 0)=0, XOR (0, 1)=1, XOR (1, 0)=1, XOR (1, 1)=0. The masked CRC bits are appended to DCI format information bits using a CRC append unit 650. An encoder 660 performs channel coding (such as tail-biting convolutional coding or polar coding), followed by rate matching to allocated resources by rate matcher 670. Interleaving and modulation units 680 apply interleaving and modulation, such as QPSK, and the output control signal 690 is transmitted.

FIG. 7 illustrates an example decoding process 700 for a DCI format for use with a UE according to embodiments of the present disclosure. An embodiment of the decoding process 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions. Other embodiments are used without departing from the scope of the present disclosure.

A received control signal 710 is demodulated and de-interleaved by a demodulator and a de-interleaver 720. A rate matching applied at a gNB transmitter is restored by rate matcher 730, and resulting bits are decoded by decoder 740. After decoding, a CRC extractor 750 extracts CRC bits and provides DCI format information bits 760. The DCI format information bits are de-masked 770 by an XOR operation with an RNTI 780 (when applicable) and a CRC check is performed by unit 790. When the CRC check succeeds (checksum is zero), the DCI format information bits are considered to be valid. When the CRC check does not succeed, the DCI format information bits are considered to be invalid.

FIG. 8 illustrates an example channel access procedure 800 according to embodiments of the present disclosure. An embodiment of the channel access procedure 800 shown in FIG. 8 is for illustration only. FIG. 8 does not limit a scope of the present disclosure.

In 3GPP standard specification, the downlink transmission including physical downlink shared channel (PDSCH) on a LAA carrier follows the category 4 listen-before-talk (Cat4 LBT) procedures (a flow chart is illustrated in FIG. 8). An eNB first stays in IDLE state (801). Depending on whether there is data traffic (811) or not, the gNB transfers to CONTEND state (802) or stays in IDLE state (801), respectively. The eNB first performs initial CCA (iCCA), where the eNB senses the channel the slot durations of a defer duration (812). If the channel is sensed as clear in the iCCA, the gNB begins to transmit (803); otherwise, the gNB generates a backoff (BO) counter (821) and perform extended CCA (eCCA). The eNB can start transmission after BO counter achieves 0 (814) as in step 4), wherein the BO counter is adjusted by sensing the channel for additional slot duration(s) according to the steps below: 1) set the counter as a random number (821) uniformly distributed between 0 and contention window size (CWS), and go to step 4; 2) if the counter is greater than 0, and the eNB chooses to decrement the counter, decrease the counter by 1 (822); 3) sense the channel for an additional slot duration, and if the additional slot duration is idle, go to step 4); else, go to step 5); 4) if the counter is 0 (814), stop; else, go to step 2). 5) sense the channel until either a busy slot is detected within an additional defer duration or all the slots of the additional defer duration are detected to be idle (815); 6) if the channel is sensed to be idle during all the slot durations of the additional defer duration, go to step 4); else, go to step 5).

The eNB can keep transmitting until the maximum channel occupancy is achieved (818). After the transmission, if the transmission is successful, the contention window size is reset (823); otherwise, the contention window size is increased (824). If the eNB still have data traffic after transmission (317), the eNB keeps contending the channel (802); otherwise, the eNB transfers to IDLE (801). If the eNB has not failed any iCCA before (816), the eNB can perform iCCA (812); otherwise, the gNB may generate a BO counter (821) and perform eCCA (813).

In LTE-LAA standard specification, for transmission including physical downlink shared channel (PDSCH), or physical downlink control channel (PDCCH), or enhanced physical downlink control channel (EPDCCH), the channel access mechanism is based on LBE, which is also referred to as category-4 (CAT-4) LBT. Specifically, an LTE-LAA eNB can transmit after sensing the channel to be idle during the slot durations of a defer duration; and after the backoff counter (BO) is zero in step 4). An example of this channel access procedure is illustrated in FIG. 8 (e.g., it is also referred to as Cat4 LBT for this type of channel access procedure).

The backoff counter is adjusted by sensing the channel for additional slot duration(s) according to the steps below: (1) set the counter as a random number uniformly distributed between 0 and contention window (CW) value, and go to step 4; (2) if the counter is greater than 0, and the eNB chooses to decrement the counter, decrease the counter by 1; (3) sense the channel for an additional slot duration, and if the additional slot duration is idle, go to step 4; else, go to step 5; (4) if the counter is 0, stop; else, go to step 2; (5) sense the channel until either a busy slot is detected within an additional defer duration or all the slots of the additional defer duration are detected to be idle; and (6) if the channel is sensed to be idle during all the slot durations of the additional defer duration, go to step 4); else, go to step 5.

In addition, for LTE-LAA, a DL transmission burst containing the discovery reference signal (DRS) without PDSCH can be transmitted after sensing the channel idle for a fixed observation interval of at least 25 μs and if the duration of the transmission is less than 1 ms. Such an LBT operation of fixed sensing interval is also referred to as Cat2 LBT.

In NR standard specification, each synchronization and PBCH signal block (SS/PBCH block) compromises of one symbol for PSS, two symbols for PBCH, one symbol for SSS and PBCH, where the four symbols are mapped consecutively, and time division multiplexed.

For initial cell selection for NR cell, a UE assumes the default SS burst set periodicity as 20 ms, and for detecting non-standalone NR cell, a network provides one SS burst set periodicity information per frequency carrier to UE and information to derive measurement timing/duration if possible. Other than the MIB, the remaining minimum system information (RMSI) is carried by physical downlink shared channel (PDSCH) with scheduling info carried by the corresponding physical downlink control channel (PDCCH). Similar structure applies to other system information (OSI) and paging message. The control resource set (CORESET) for receiving common control channels, such as RMSI, is configured in content of PBCH.

In NR-U, the transmission of SS/PBCH blocks may also be subject to the sensing result of LBT, such that the UE cannot always expect to receive the SS/PBCH blocks periodically. To address the LBT uncertainty of SS/PBCH block transmissions in NR-U, a discovery reference signal and channel, which can be referred to as DRS for the rest of the present disclosure, can be supported for NR-U. The DRS can contain SS/PBCH block(s), and configurable CORESET(s) and PDSCH(s) of RMSI, OSI, or paging, as well as configurable channel state indicator reference signal (CSI-RS).

In addition, for transmission of SS/PBCH blocks in NR-U DRS, a DRS transmission timing configuration (short for DTTC) method can be considered for NR-U, wherein the configuration contains a window periodicity, a window duration, and a window offset. The DRS can be subject to a single-shot LBT of fixed duration (e.g., 25 μs for FR1 NR-U).

In one embodiment, a type of UL transmissions for a UE to a gNB COT sharing is provided. In such embodiment, principles are provided on allowing the UE to share COT with a serving gNB and the type of UL transmissions that a gNB can share the UE-initiated COT.

In one embodiment, a gNB can share the COT obtained by an associated UE, wherein the COT is obtained through a CAT-4 LBT by the UE.

In one embodiment, the gNB can share the COT obtained by one of an associated UE for DL transmissions.

In one example, the gNB can share the COT obtained by an associated UE obtained through a CAT-4 LBT; wherein the gNB can share all or a subset of the remaining MCOT after the end of the UL transmissions by the UE.

In another example, the gNB can share MCOT of an associated UE subject to an LBT operation, wherein the LBT type can depend on the gap duration at the UL to DL switching point. In one sub-example, the LBT can be a CAT-2 LBT if the gap is larger than 16 μs and CAT-1 LBT (i.e., no LBT) is the gap is smaller than or equal to 16 μs.

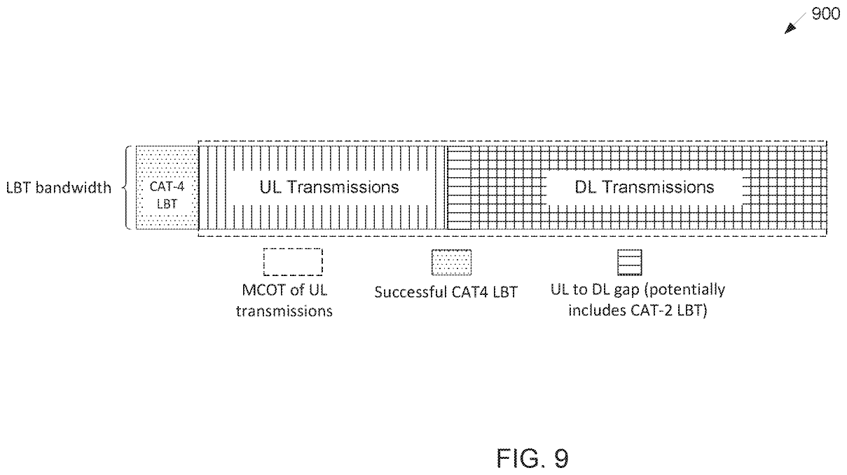

FIG. 9 illustrates an example UL transmission 900 according to embodiments of the present disclosure. An embodiment of the UL transmission 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 9, the MCOT is obtained by a UE through a CAT-4 LBT, and the serving gNB of the UE can share the UE's MCOT after potentially a CAT-2 LBT at the UL to DL switching gap.

In one example, for one or more associated UEs of a gNB wherein each UE has obtained a respective COT through CAT-4 on frequency resources corresponding to a desired UL transmission, and the COTs of these associated UEs can have overlapping durations after their respective UL transmissions; the gNB can share the common remaining COTs after the end of the UL transmissions for these associated UEs subject to LBT allowance.

In one example, the gNB can share the remaining COT of a UE if the gNB has passed LBT at the UL to DL switching point over the frequency resources wherein the UE has passed the CAT-4 LBT in obtaining the current COT.

In one example, for the UE-initiated COT(s) wherein the gNB has passed LBT according to the aforementioned examples, the gNB can share at least the common remaining duration of these COTs (i.e., after the end of the UL transmissions by these UEs) in time domain, over the union of the frequency resources wherein the UE has passed the CAT-4 LBT in obtaining the corresponding COT.

In one example, the gNB can share the COT obtained by an associated UE(s), wherein the uplink transmission can be one or more than one of the following examples.

In one example, the gNB can share the COT obtained by an associated UE(s), wherein the uplink transmission can be scheduled uplink data transmission(s), i.e., PUSCHs.

In one sub-example, the scheduled PUSCH can refer to the PUSCH scheduled by the UL grant through PDCCH with DCI format 0_0 or DCI format 0_1.

In another sub-example, the scheduled PUSCH can also include the Msg3 of the random access procedure, wherein the Msg3 is scheduled by the UL grant in Msg2.

In one example, the gNB can share the COT obtained by an associated UE(s), wherein the uplink transmission can be configured grant (CG) uplink transmission(s).

In one example, the gNB can share the COT obtained by an associated UE(s), wherein the uplink transmission can be UL data transmission(s) other than the scheduled or CG uplink transmissions.

In one example, the uplink transmission can be a standalone physical random access channel (PRACH) transmission, wherein the PRACH COT is obtained through CAT-4 LBT.

In one example, the uplink transmission can be a standalone sounding reference signal (SRS) transmission, wherein the SRS COT is obtained through CAT-4 LBT.

In one example, the uplink transmission can be a standalone PUCCH transmission, wherein the PUCCH COT is obtained through CAT-4 LBT.

In one sub-example, the standalone PUCCH transmission can include HARQ-ACK feedbacks corresponding to previous DL data transmissions.

In another sub-example, the standalone PUCCH transmission can include channel state information or scheduling request.

In one embodiment, frequency and time domain resource for gNB within shared COT is provided. In such embodiment, for the frequency and time domain resources, the gNB can be shared from the UE-initiated COT obtained by one of associated UEs.

In one example, the frequency domain granularity for LBT operations at each UE can be performed in a frequency-domain unit, which can be referred to as an LBT bandwidth.

In one example, when the scheduled UL bandwidth is smaller than one LBT bandwidth, the UE can perform LBT over the LBT bandwidth that covers the scheduled UL bandwidth.

In one example, when the scheduled UL bandwidth is more than one LBT bandwidths, the UE can perform multiple LBT operations in parallel, wherein each LBT operation is performed over an LBT bandwidth that overlaps with the scheduled UL bandwidth. In one sub-example, different LBT bands wherein the UE performs LBT can be non-overlapping in frequency domain.

In one example, the LBT bandwidth for FR1 NR-U can be 20 MHz, and the center frequency of each LBT bandwidth can be aligned with the center frequency of the nominal channels defined in the unlicensed regulation.

In one example, the frequency domain resource that the gNB can share from the UE-initiated COT is all or a subset of the LBT bandwidths over which the UE has passed the CAT-4 LBT operation in obtaining the UE-initiated COT.

In one example, if the bandwidth of the intended UL transmission at the UE is greater than the LBT bandwidth, the gNB can share the UE-initiated COT over all of the LBT bandwidths of the UL transmission for which the UE CAT-4 LBT is successful, subject to a gNB LBT allowance at the UL to DL switching point; and the gNB cannot share the UE-initiated COT over LBT bandwidths wherein the UE fails the LBT.

In one example, it can be up to a gNB scheduler decision to share the UE-initiated COT over a subset of the LBT bandwidths of the UL transmission for which the UE CAT-4 LBT is successful, subject to a gNB LBT allowance at the UL to DL switching point.

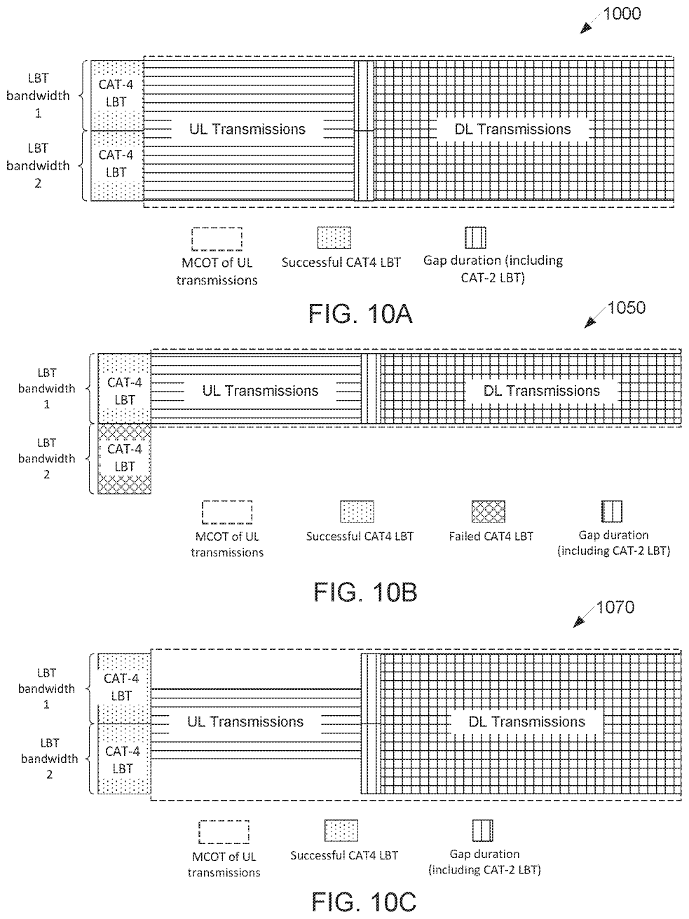

In one example, if the intended UL transmission consists of a set of an integer number of LBT bandwidths, and the UL LBT is successful in every LBT bandwidth of the intended UL transmission; the gNB can share the UE-initiated COT over all or a subset of this set of LBT bandwidths. An illustration of this sub-example is provided in FIG. 10A, the UE is scheduled with UL transmissions that spans over both LBT bandwidth 1 and LBT bandwidth 2, in addition the UE has succeeded CAT-4 LBT in both LBT bandwidth 1 and LBT bandwidth 2 in obtaining the COT; and therefore in frequency domain, the gNB can use all or a subset of the union of LBT bandwidth 1 and LBT bandwidth 2 for DL transmissions that share the UE-initiated COT.

FIG. 10A illustrates another example UL transmission 1000 according to embodiments of the present disclosure. An embodiment of the UL transmission 1000 shown in FIG. 10A is for illustration only. One or more of the components illustrated in FIG. 10A can be implemented in specialized circuitry configured to perform the noted functions or one or more of the components can be implemented by one or more processors executing instructions to perform the noted functions. Other embodiments are used without departing from the scope of the present disclosure.

In another sub-example, if the intended UL transmission consists of a set of an integer number of LBT bandwidths, and the UL LBT is successful in a subset of the LBT bandwidths of the intended UL transmission; the gNB can share the UE-initiated COT over all or a subset of the subset of LBT bandwidths wherein the LBT is successful. An illustration is provided in FIG. 10B, the UE has succeeded CAT-4 LBT in LBT bandwidth 1 but failed in LBT bandwidth 2 in obtaining the COT; and therefore in frequency domain, the gNB can use all or a subset of only LBT bandwidth 1 for DL transmissions when sharing the UE-initiated COT.

FIG. 10B illustrates yet another example UL transmission 1050 according to embodiments of the present disclosure. An embodiment of the UL transmission 1050 shown in FIG. 10B is for illustration only. One or more of the components illustrated in FIG. 10B can be implemented in specialized circuitry configured to perform the noted functions or one or more of the components can be implemented by one or more processors executing instructions to perform the noted functions. Other embodiments are used without departing from the scope of the present disclosure.

FIG. 10C illustrates yet another example UL transmission 1070 according to embodiments of the present disclosure. An embodiment of the UL transmission 1070 shown in FIG. 10C is for illustration only. One or more of the components illustrated in FIG. 10C can be implemented in specialized circuitry configured to perform the noted functions or one or more of the components can be implemented by one or more processors executing instructions to perform the noted functions. Other embodiments are used without departing from the scope of the present disclosure.

In another sub-example, if the intended UL transmission overlaps with a set of integer number of LBT bandwidths but not completely covering this set of LBT bandwidths, the gNB can share the UE-initiated COT over all or a subset of the LBT bandwidths which have overlapping frequency resources with the intended UL transmission of the UE, and that the UL LBT by the UE is successful on such LBT bandwidths. An illustration is provided in FIG. 10C, wherein the intended/scheduled UL transmission partially overlaps with both LBT bandwidth 1 and LBT bandwidth 2, and that the UE needs to perform LBT at both LBT bandwidth 1 and LBT bandwidth 2.

In the example of FIG. 10C, a UE has succeeded in LBT on both LBT bandwidth 1 and LBT bandwidth 2, and that the UE UL transmission over the intended/scheduled bandwidth can block LBT operations performed by nearby initiating devices on LBT bandwidth 1 and/or LBT bandwidth 2, therefore the gNB is able to share the UE-initiated COT over all or a subset of the LBT bandwidth 1 and LBT bandwidth 2, subject to LBT allowance.

FIGS. 10A, 10B, and 10C can be extended to scenarios with different number of LBT bandwidths for the intended UL transmission as well.

In one example, if the bandwidth of the intended UL transmission at the UE is no larger than an LBT bandwidth, the gNB can share the UE-initiated COT over all of the LBT bandwidth for which the CAT-4 LBT is successful at the UE, subject to a gNB LBT allowance at the UL to DL switching point.

In one sub-example, if the intended UL transmission partially overlaps with an LBT bandwidth, the gNB can share the UE-initiated COT over the entire LBT bandwidth which have overlapping frequency resources with the intended UL transmission of the UE, provided that the UL LBT by the UE is successful on this LBT bandwidth and the gNB LBT (if any) at the UL to DL switching point is successful.

In another sub-example, it can also be up to a gNB scheduler decision to share the UE-initiated COT over a subset of the LBT bandwidth for which the CAT-4 LBT is successful at the UE, subject to a gNB LBT allowance at the UL to DL switching point.

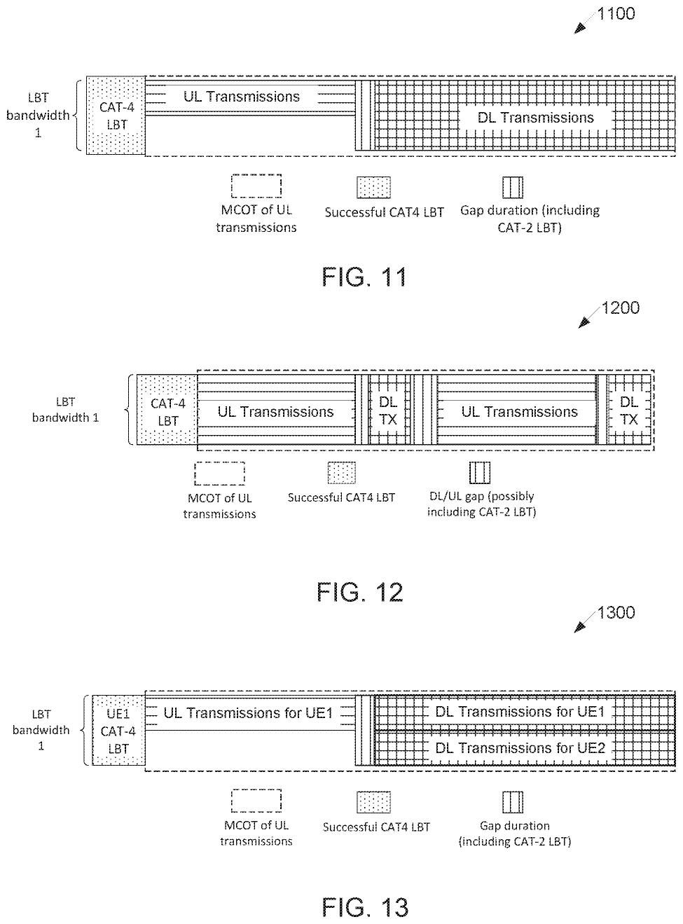

FIG. 11 illustrates an example intended UL transmission 1100 according to embodiments of the present disclosure. An embodiment of the UL transmission 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions. Other embodiments are used without departing from the scope of the present disclosure.

AS illustrated in FIG. 11, the intended/scheduled UL transmission is a subset of LBT bandwidth 1, and that the UE has succeeded in the CAT-4 LBT over LBT bandwidth 1, and that the UE UL transmission over the intended/scheduled bandwidth can block LBT operations performed by nearby initiating devices on LBT bandwidth 1, therefore the gNB is able to share the UE-initiated COT over all or a subset of the LBT bandwidth 1, subject to a gNB LBT allowance.

In one example, the gNB can implicitly determine if the UE LBT is successful at an LBT bandwidth through detecting the existence of the scheduled UL transmissions from the UE over the scheduled frequency resources; and the gNB determines the UE LBT is successful if the UL transmission has been detected within certain durations, otherwise the UE LBT is considered unsuccessful.

In one sub-example, if the scheduled/intended UL transmission has been detected on an LBT bandwidth, the gNB can determine the UE LBT over this LBT bandwidth as successful and therefore can potentially share the UE-initiated COT over this LBT bandwidth.

In one example, the gNB can explicitly determine if the UE LBT is successful at an LBT bandwidth through explicit UE indication from the UL.

In one sub-example, the UE explicit indication can be transmitted through the PUSCH content, wherein the PUSCH content can indicate the LBT bandwidth(s) wherein the UE has succeeded in LBT. For instance, the indication of this PUSCH content can be carried through UL grant.

In another sub-example, the UE explicit indication can be transmitted through UL signal, such as through DM-RS sequence for PUSCH/PUCCH, or a new UL signal (e.g., preamble).

In one example, the gNB may not share the UE-initiated COT over the frequency-domain resources wherein the UE has not passed the CAT-4 LBT, or the UE has not performed CAT-4 LBT operation, in obtaining the current COT of the UE.

In one example, only one UL to DL switching can be allowed within the UE-initiated COT, such that the COT can be shared from the UE to a gNB subject to a gNB LBT allowance at the switching point, and the gNB can use all or a subset of the remaining UE-initiated COT in time domain.

In one example, the gNB LBT at the UL to DL switching point can be a CAT-2 LBT of 25 μs when the UL to DL switching gap is larger than or equal to 25 μs. In one sub-example, the gNB scheduler can ensure a gap between 25 μs and 100 μs may not happen, subject to the regulation constraint in 5 GHz unlicensed bands.

In one example, the gNB LBT at the UL to DL switching point can be a CAT-2 LBT of X μs when the UL to DL switching smaller than 25 μs, wherein X<25 μs. In one sub-example, the detailed definition of CAT-2 LBT of X μs (X<25) is detailed in the present disclosure.

In one example, the gNB LBT at the UL to DL switching point can be CAT-1 LBT (i.e., no LBT) at the UL to DL switching gap, when the gap duration is smaller or equal to 16 μs.

Ad illustrated in FIG. 9, there is only 1 UL to DL switching point, and the gNB can share the remaining COT after the UL to DL switching point.

In one example, one or more than one UL to DL switching and DL to UL switching can be allowed within the UE initiated COT, subject to all or a subset of constraints on: gap duration at the switching point(s), the duration of the downlink transmission that is transmitted by sharing the UE-initiated COT, the type of downlink transmission that is transmitted by the gNB through sharing UE-initiated COT, a maximum allowed number of DL/UL switching point within a COT.

In one example, the constraint on gap duration at the switching point can be that the switching point duration is smaller or equal to 25 μs for FR1 NR-U. In one sub-example, this gap duration can be applied to one or both of the DL to UL switching and UL to DL switching.

In one example, the constraint on duration of the downlink transmission that is transmitted by sharing the UE-initiated COT can be a fixed duration T, which can be defined according to unlicensed regulation, or the coexisting radio access technology in the unlicensed band, or depending on the LBT type applied at the DL/UL switching point. For instance, T can be 500 μs for FR1 NR-U if CAT-1 LBT is applied at the DL/UL switching point.

In one example, if the constraint for multiple DL/UL switching within the UE-initiated COT is not met, only one UL to DL switching can be allowed within the UE-initiated COT, such that the COT can be shared from a UE to a gNB subject to LBT allowance at the switching point, and the gNB can use all or a subset of the remaining UE-initiated COT in time domain.

In one example, the type of downlink transmission that can transmitted by the gNB through sharing UE-initiated COT with multiple UL/DL switching points can include UL grant (which schedules UL transmissions), PDCCH transmissions.

In one example, more than one UL/DL switching points can be supported if the constraints to allow multiple UL/DL switching points (e.g., such as according to all or a subset of the aforementioned examples and/or embodiments) are met; otherwise at most a single UL/DL switching point can be allowed according to the aforementioned examples and/or embodiments.

FIG. 12 illustrates an example UL transmission with constraint 1200 according to embodiments of the present disclosure. An embodiment of the UL transmission with constraint 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 12, the constraint is on the maximum DL transmission duration that a gNB is allowed to share from the UE-initiated COT, and multiple DL/UL switching points can be allowed when this constraint is met.

In one example, when a gNB shares the UE-initiated COT(s) for downlink transmissions, such downlink transmissions can be transmissions that are only addressed to the UE(s) that obtains the COT(s).

In one example, the DL transmissions can be PDSCH/PDCCH transmissions corresponding to the UL data transmission of the UE(s) that is transmitted within the UE-initiated COT(s) (i.e., a UE obtains the COT after successful CAT-4 LBT to transmit the UL data transmissions).

In one sub-example, the UL data transmission can be regular PUSCH transmission scheduled by UL grant.

In another sub-example, the UL data transmission can be CG-PUSCH.

For instance, the DL transmissions can be UL grant that includes ACK/NACK corresponding to the scheduled UL data transmission or CG-PUSCH transmission.

In one example, the DL transmission can be an UL grant that schedules another UL data transmission for the UE that initiated the COT. In one instance, the DL transmission can be the UL grant that activates/deactivates the CG-PUSCH transmission for the UE. In another instance, the DL transmission can be the UL grant that schedules regular PUSCH transmission for the UE.

In one example, the DL transmission can be Msg2 transmission of the random access procedure, which corresponds to the Msg1 transmission from the UE wherein the Msg1 is transmitted within a UE-initiated COT (i.e., a UE obtains the COT after successful CAT-4 LBT to transmit the Msg1).

In one example, the DL transmission can be Msg4 transmission of the random access procedure, which corresponds to the Msg3 transmission from the UE wherein the Msg3 is transmitted within a UE-initiated COT (i.e., a UE obtains the COT after successful CAT-4 LBT to transmit the Msg3).

In one example, the DL transmission can be unicast PDSCH/PDCCH transmissions addressed to the UE that obtains the UE-initiated COT.

In one sub-example, the PDSCH transmission can be new PDSCH transmissions towards the UE. For instance, this can be applied when PUCCH is transmitted within UE-initiated COT which indicates ACK for the previous PDSCH transmission towards the UE.

In another sub-example, the PDSCH transmission can be retransmitted PDSCH towards the UE. For instance, this can be applied when PUCCH is transmitted within UE-initiated COT which indicates NACK for the previous PDSCH transmission towards the UE.

In one example, the DL signals/channels that are transmitted by sharing the UE-initiated COT, can be transmitted only using the same spatial TX parameter(s) that the gNB used in transmitting to the UE(s) that obtains the current UE-initiated COT(s).

In one example, when a gNB shares the UE-initiated COT(s) for downlink transmissions, the gNB can also use shared COT to transmit downlink signals/channels that are addressed to UE(s) other than the UE(s) that obtains the COT(s).

In one example, the scheduled/intended UL transmission partially overlaps with one or multiple LBT bandwidths; such that the gNB can use the partial frequency resources of the LBT bandwidths that do not overlap with the scheduled/intended UL transmission for downlink transmissions to UE(s) other than the UE(s) in obtaining the COT.

In one example, the DL signals/channels that are transmitted by sharing the UE-initiated COT can at least include the DL signal(s)/channel(s) that are intended to the UE that obtains the COT.

In one sub-example, the gNB may not transmit DL signals/channels to other UEs without transmitting DL signal(s)/channel(s) to the UE that obtains the COT.

In one example, the DL signals/channels that are transmitted by sharing the UE-initiated COT do not need to include the DL signal(s)/channel(s) that are intended to the UE that obtains the COT.

In one example, the DL transmissions can include broadcast or non-unicast DL signals/channels.

For instance, such broadcast or non-unicast DL signals/channels can include one or multiple of the SS/PBCH blocks; NR-U discovery reference signal (DRS); remaining system information (RMSI) or SIB1; other system information (OSI); paging; group-common PDCCH; or other PDCCH with common search space.

In one example, the DL transmissions can include DL signals/channels addressed to a UE group.

In one sub-example, the UE group can include the UE(s) that obtained the UE-initiated COT. In another sub-example, such DL signals/channels can be broadcast or multi-cast signals/channels addressed to a group of UEs.

In one example, the DL signals/channels that are transmitted by sharing the UE-initiated COT, can be addressed to UE(s) that do not include the UE(s) which obtained the UE-initiated COT.

In one example, the DL signals/channels that are transmitted by sharing the UE-initiated COT, can be transmitted only using the same spatial TX parameter(s) that the gNB used in transmitting to the UE(s) that obtains the current UE-initiated COT(s).

In one example, when a gNB shares the UE-initiated COT(s) for downlink transmissions, the downlink transmission needs to meet one of the following conditions: only the DL signals/channels that satisfy the aforementioned embodiments and/or examples can be transmitted by sharing the UE-initiated COT; only the DL signals/channels that satisfy the aforementioned embodiment can be transmitted by sharing the UE-initiated COT; and the DL signals/channels that satisfy the aforementioned embodiments can be transmitted by sharing the UE-initiated COT.

FIG. 13 illustrates an example UL transmission 1300 according to embodiments of the present disclosure. An embodiment of the UL transmission 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 13, the gNB can transmit DL signals/channels to UE1 by sharing the same frequency resource as the scheduled UL transmission for UE1 within the shared UE1-initiated COT, and a gNB can also use the remaining frequency resources of the LBT bandwidth 1 for DL transmissions to another UE (e.g., UE2). This is feasible since UE1 has passed CAT-4 LBT over the entire LBT bandwidth 1, and the gNB has passed CAT-1/CAT-2 LBT over the entire LBT bandwidth 1 at the UL to DL switching point.

In one embodiment, LBT rules to grant a UE to a gNB COT sharing under NR-U wideband operation is provided.

In one example, one consideration is provided. In such example, the consideration for a UE to a gNB COT sharing is that for a wideband UL transmission wherein the UE is scheduled to transmit over multiple LBT bandwidths, or when multiple UEs have been scheduled for UL transmission across different LBT bandwidths; how the gNB can efficiently share the UE-initiated COT s across multiple LBT bandwidths.

In one example, when one UE is scheduled on multiple LBT bandwidths and have succeeded in CAT-4 LBT across multiple of the scheduled LBT bandwidths; as well as when multiple UEs associated with the gNB are scheduled on different LBT bandwidths, and that multiple UEs have passed the respective CAT-4 LBT and have obtained the COT.

In one example, the gNB can apply a self-deferral duration across different LBT bandwidths corresponding to the COTs of the UE(s) that the gNB intends to share, such that the LBT operations across such LBT bandwidths can be performed at the same time instance.

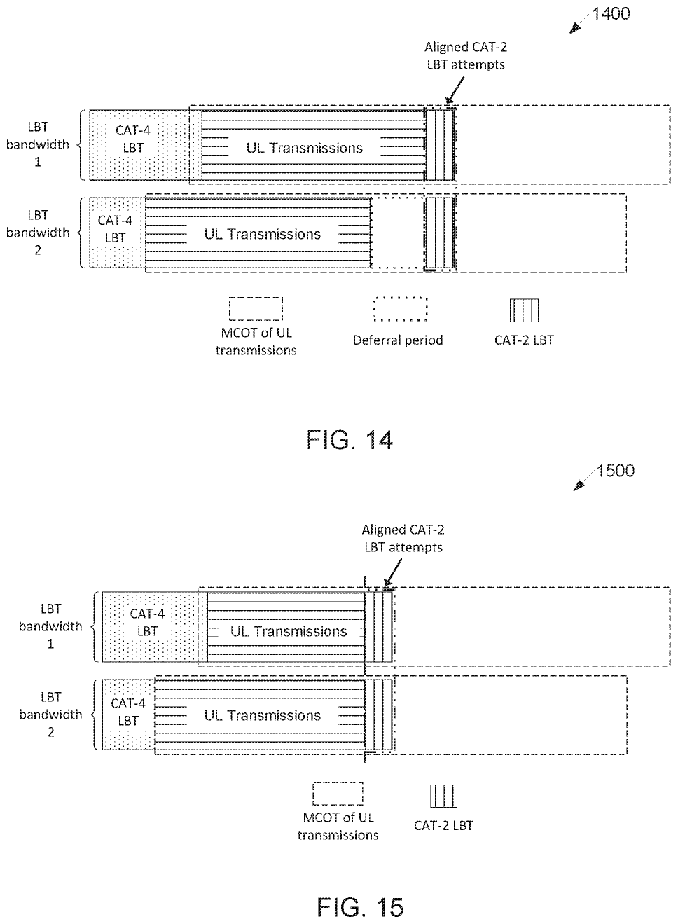

FIG. 14 illustrates an example UL transmission for two LBT bandwidth 1400 according to embodiments of the present disclosure. An embodiment of the UL transmission for two LBT bandwidth 1400 shown in FIG. 14 is for illustration only. One or more of the components illustrated in FIG. 14 can be implemented in specialized circuitry configured to perform the noted functions or one or more of the components can be implemented by one or more processors executing instructions to perform the noted functions. Other embodiments are used without departing from the scope of the present disclosure.

In one example, as illustrated in FIG. 14, the gNB can apply self-deferral after the end of scheduled UL transmission on LBT bandwidth 2; such that the gNB can attempt CAT-2 LBT at LBT bandwidth 1 and LBT bandwidth 2 respectively at an aligned time position. In addition, the LBT bandwidth wherein the gNB has CAT-2 passed LBT can be utilized by the gNB for DL transmission(s).

The example as illustrated in FIG. 14 with two LBT bandwidths is for illustration purpose only, and this example can be extended to when the scheduled UL transmission(s) span over more than two LBT bandwidths as well. It can also be applied to when the LBT bandwidths are contiguous to each other or have gaps in between different LBT bandwidths.

In one example, the gNB can schedule the UL transmissions such that the ending positions of UL transmissions are aligned across different LBT bandwidths corresponding to the COTs of the UE(s) that a gNB intends to share.

In one example, since the CAT-4 LBT duration is non-deterministic at each UE-side, the gNB can indicate a desired ending timing position through PDCCH or PDSCH, such that the UE transmissions across different LBT bandwidths may be punctured if the UL transmission on a given LBT bandwidth is not finished by the indicated ending timing position.

In one sub-example, the desired ending timing position can be indicated through the UL grant via DCI format 0_0 or DCI format 0_1. For instance, the desired ending timing position can be explicitly indicated in the UL grant. In another instance, the desired ending timing position can be implicitly indicated through a timer duration, such that the timer starts when the UE receives the UL grant, and expires at the gNB desired ending timing position.

In another sub-example, the desired ending timing position can be indicated through a group-common PDCCH. For instance, the desired ending timing position can be explicitly indicated in the GC-PDCCH. In another instance, the desired ending timing position can be implicitly indicated through a timer duration, such that the timer starts when the UE receives the GC-PDCCH and expires at the gNB desired ending timing position.

FIG. 15 illustrates another example UL transmission for two LBT bandwidth 1500 according to embodiments of the present disclosure. An embodiment of the UL transmission for two LBT bandwidth 1500 shown in FIG. 15 is for illustration only. One or more of the components illustrated in FIG. 15 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 15, the gNB can schedule the UL transmissions on LBT bandwidth 1 and LBT bandwidth 2 such that both transmissions may end at an aligned time-domain position. In addition, the LBT bandwidth wherein the gNB has CAT-2 passed LBT can be utilized by the gNB for DL transmission(s).

The example as illustrated in FIG. 15 with two LBT bandwidths is for illustration purpose only, and this example can be extended to when the scheduled UL transmission(s) span over more than two LBT bandwidths as well. It can also be applied to when the LBT bandwidths are contiguous to each other or have gaps in between different LBT bandwidths.

In one example, when there are multiple LBT bandwidths corresponding to the COTs of the UE(s) that a gNB intends to share, the gNB can perform LBT at each such LBT bandwidth respectively at the end of the UL transmission in the corresponding LBT bandwidth, while pausing ongoing DL transmissions (if any) on other LBT bandwidths; and the gNB can stop receiving uplink transmissions after the first of such LBT operation and can transmit DL transmission in all or a subset of the LBT bandwidths that have passed the LBT.

In one example, if full duplex is supported, it can be extended to allow the gNB to continue receiving uplink transmissions on an LBT bandwidth while transmitting DL signals/channels on another LBT bandwidth.

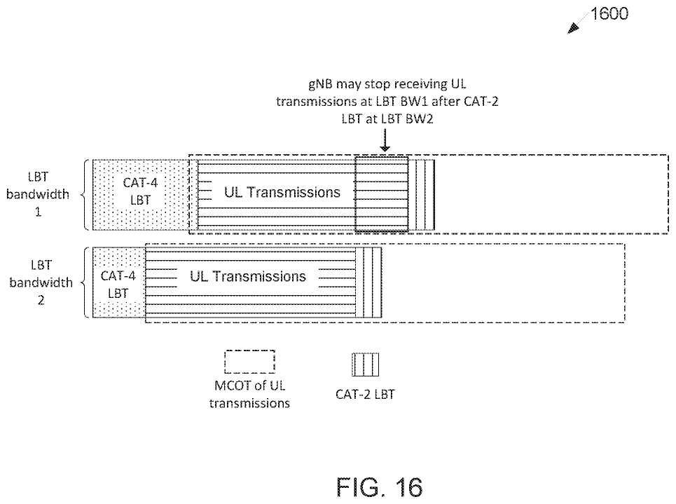

FIG. 16 illustrates yet another example UL transmission for two LBT bandwidth 1600 according to embodiments of the present disclosure. An embodiment of the UL transmission for two LBT bandwidth 1600 shown in FIG. 16 is for illustration only. One or more of the components illustrated in FIG. 16 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 16, the gNB performs LBT over LBT bandwidth 2 at the end of UL transmissions at LBT bandwidth 2; meanwhile the gNB can stop receiving remaining UL transmissions over LBT bandwidth 1 if the gNB can use LBT bandwidth 2 for DL transmissions. In addition, the gNB performs LBT over LBT bandwidth 1 at the end of UL transmissions at LBT bandwidth 1, meanwhile pausing the DL transmissions (if any) over LBT bandwidth 2.

The example as illustrated in FIG. 16 with two LBT bandwidths is for illustration purpose only, and this example can be extended to when the scheduled UL transmission(s) span over more than two LBT bandwidths as well. It can also be applied to when the LBT bandwidths are contiguous to each other or have gaps in between different LBT bandwidths.

In one example, the gNB can adjust the duration of the CAT-2 LBT across different LBT bandwidths that the gNB intends to share, such that the ending positions of the CAT-2 LBT operations across different LBT bandwidths are aligned, and the gNB can utilize the LBT bandwidths that have passed LBT to share the COT from the UEs for DL transmissions at an aligned starting position.

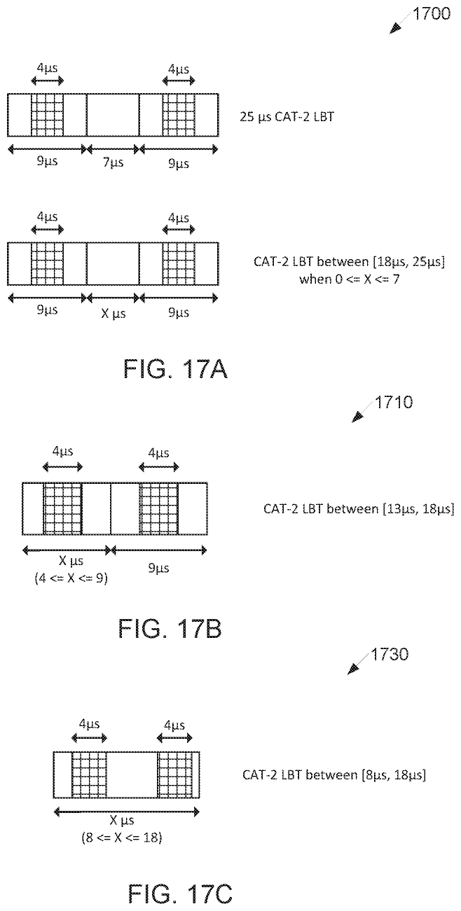

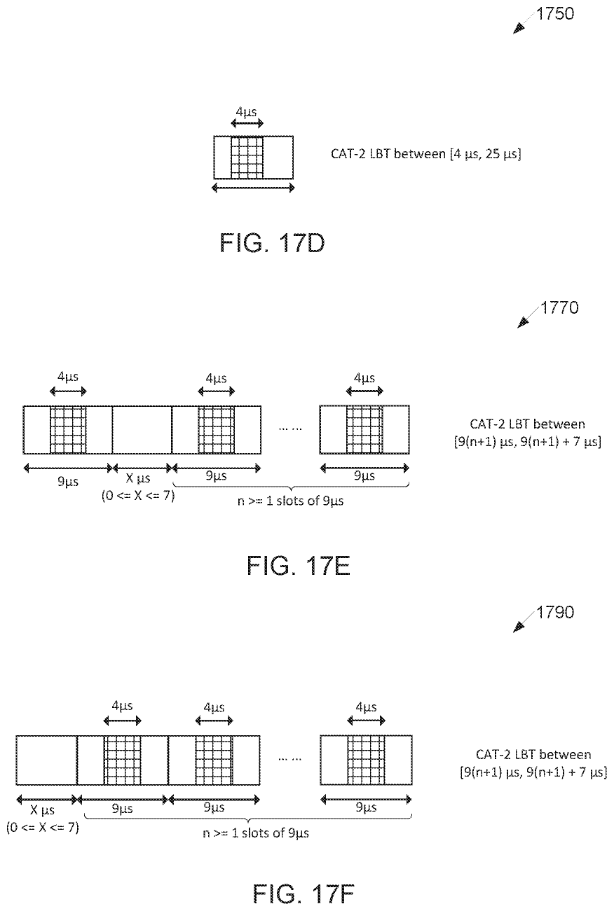

Examples of CAT-2 LBT operations of various durations for FR1 NR-U are illustrated in FIG. 17A to 17F, wherein the CAT-2 LBT is considered successful if all the measurement period(s) within the CAT-2 LBT duration have the power detected to be below the energy detection threshold.

FIG. 17A illustrates an example CAT-2 LBT 1700 according to embodiments of the present disclosure. An embodiment of the CAT-2 LBT 1700 shown in FIG. 17A is for illustration only. One or more of the components illustrated in FIG. 17A can be implemented in specialized circuitry configured to perform the noted functions or one or more of the components can be implemented by one or more processors executing instructions to perform the noted functions. Other embodiments are used without departing from the scope of the present disclosure.

AS illustrated in FIG. 17A, the CAT-2 LBT includes two slots of 9 μs each, wherein each slot contains a measurement period for at least 4 μs, and there is a measurement gap of X μs in between the two slots.

FIG. 17B illustrates another example CAT-2 LBT 1710 according to embodiments of the present disclosure. An embodiment of the CAT-2 LBT 1710 shown in FIG. 17B is for illustration only. One or more of the components illustrated in FIG. 17B can be implemented in specialized circuitry configured to perform the noted functions or one or more of the components can be implemented by one or more processors executing instructions to perform the noted functions. Other embodiments are used without departing from the scope of the present disclosure.

AS illustrated in FIG. 17B, the CAT-2 LBT includes two slots of X μs and 9 μs respectively, wherein each slot contains a measurement period for at least 4 μs.

FIG. 17C illustrates yet another example CAT-2 LBT 1730 according to embodiments of the present disclosure. An embodiment of the CAT-2 LBT 1730 shown in FIG. 17C is for illustration only. One or more of the components illustrated in FIG. 17C can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 17C, the CAT-2 LBT includes a duration of X μs, which contains two measurement periods for at least 4 μs each.

FIG. 17D illustrates yet another example CAT-2 LBT 1750 according to embodiments of the present disclosure. An embodiment of the CAT-2 LBT 1750 shown in FIG. 17D is for illustration only. One or more of the components illustrated in FIG. 17D can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 17D, the CAT-2 LBT includes a duration of X μs, which contains one measurement period for at least 4 μs.

FIG. 17E illustrates yet another example CAT-2 LBT 1770 according to embodiments of the present disclosure. An embodiment of the CAT-2 LBT 1770 shown in FIG. 17E is for illustration only. One or more of the components illustrated in FIG. 17E can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 17E, the CAT-2 LBT includes (n+1) slots of 9 μs each, wherein each slot contains a measurement period for at least 4 μs, and there is a measurement gap of X μs between the first slot and the second slot.

FIG. 17F illustrates yet another example CAT-2 LBT 1790 according to embodiments of the present disclosure. An embodiment of the CAT-2 LBT 1790 shown in FIG. 17F is for illustration only. One or more of the components illustrated in FIG. 17F can be implemented in specialized circuitry configured to perform the noted functions or one or more of the components can be implemented by one or more processors executing instructions to perform the noted functions. Other embodiments are used without departing from the scope of the present disclosure.

As illustrated in FIGURE F, the CAT-2 LBT includes (n+1) slots of 9 μs each, wherein each slot contains a measurement period for at least 4 μs, and there is a measurement gap of X μs before the first slot.

In one sub-example, the example definitions of CAT-2 LBT as illustrated in FIG. 17A to 17F can be applied to general operations of an initiating device for FR1 NR-U, in addition to the UL to DL COT sharing as detailed in the current disclosure.

In one example, the gNB can apply CAT-2 LBT operations of different durations across the LBT bandwidths that the gNB intends to share, such that the ending positions of CAT-2 LBT operations can be aligned, and the LBT bandwidth(s) wherein the gNB has passed CAT-2 LBT operation can be used for DL transmission(s).

In one sub-example, when the UL to DL switching gap is smaller than or equal to 16 μs, a CAT-1 LBT (i.e., no LBT) can also be applied.

In another sub-example, due to the non-deterministic duration of CAT-4 LBT, the gNB can derive the desired ending position of the UL transmission on each LBT bandwidth by either explicitly indication through UL grant; or by implicitly derivation through detecting the starting time position of the UL transmission and the scheduled UL transmission duration. Based on the desired ending position of the UL transmission on each LBT bandwidth, the gNB can correspondingly determine the CAT-2 LBT duration for each LBT bandwidth.

In another sub-example, the ending position of CAT-2 LBT operations at different LBT bandwidths can be considered as aligned if the maximum time difference of the ending positions of the CAT-2 LBTs is smaller than a threshold Y μs. For instance, Y can be smaller than or equal to 9. In another instance, Y can be chosen such that the gNB may not lose the channel in an LBT bandwidth if a deferral period of Y μs is applied by the gNB after a successful CAT-2 LBT operation. This sub-example can also be applied to the other parts of this disclosure where aligned time position is used.

In one example, the aforementioned examples and/or embodiments may be applied when the maximum difference of the ending positions of UL transmissions at different LBT bandwidths (that a gNB intends to share) are no larger than the maximum allowed duration of the CAT-2 LBT supported by FR1 NR-U.

As illustrated in FIG. 17A to 17F, since the CAT-4 LBT at LBT bandwidth 1 by the UE is finished later than the CAT-4 LBT at LBT bandwidth 2, the gNB applies a shorter CAT-2 LBT duration at LBT bandwidth 1 compared to that on LBT bandwidth 2, such that DL transmissions on LBT bandwidth 1 and LBT bandwidth 2 can start at an aligned timing position.

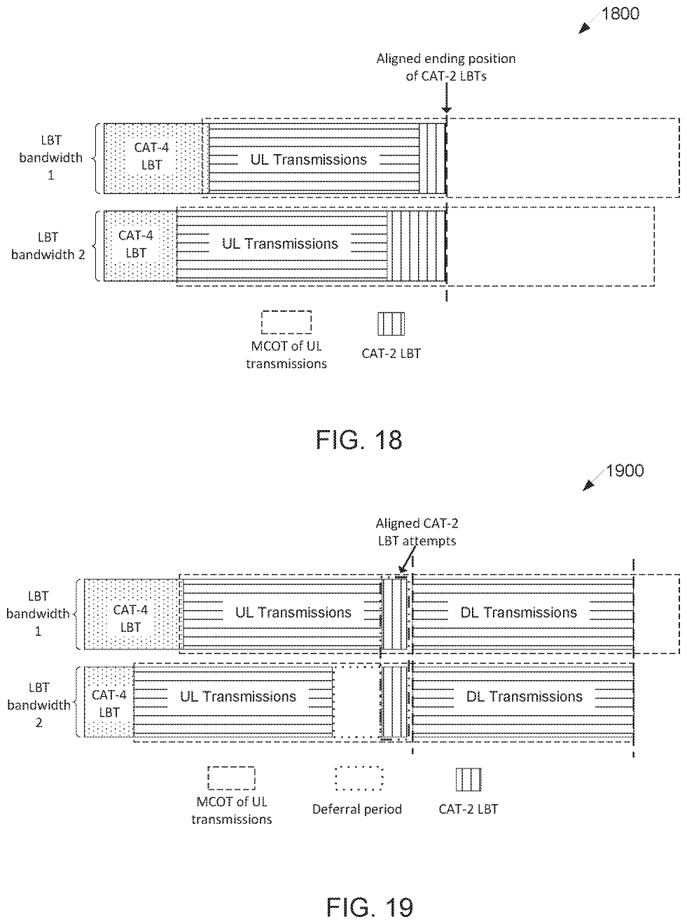

FIG. 18 illustrates an example UL transmission with two LBT bandwidth 1800 according to embodiments of the present disclosure. An embodiment of the UL transmission with two LBT bandwidth 1800 shown in FIG. 18 is for illustration only. One or more of the components illustrated in FIG. 18 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 18, two LBT bandwidths are for illustration purpose only, and this example can be extended to when the scheduled UL transmission(s) span over more than two LBT bandwidths as well. It can also be applied to when the LBT bandwidths are contiguous to each other or have gaps in between different LBT bandwidths.

In one example, the maximum duration of the COT that can be shared by the gNB from associated UEs can be the intersection of the remaining COTs of each UE (that have passed CAT-4 LBT) after the LBT attempt by the gNB at the UL to DL switching point, wherein the gNB has passed the LBT attempt.

FIG. 19 illustrates another example UL transmission with two LBT bandwidth 1900 according to embodiments of the present disclosure. An embodiment of the UL transmission with two LBT bandwidth 1900 shown in FIG. 19 is for illustration only. One or more of the components illustrated in FIG. 19 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 19, the UL transmission on LBT bandwidth 1 starts later than the UL transmission on LBT bandwidth 2 due to different CAT-4 LBT operation, and thus the MCOT of LBT bandwidth 1 finishes later than the MCOT of LBT bandwidth 2. The gNB applies a self-deferral period at LBT bandwidth 2 to align the CAT-2 LBT attempt position, and that the gNB has passed both CAT-2 operations. According to the aforementioned embodiments, DL transmissions by the gNB on both LBT bandwidth 1 and LBT bandwidth 2 needs to be contained within the intersection of remaining MCOT of LBT bandwidth 1 and remaining MCOT of LBT bandwidth 2.

The example as illustrated in FIG. 19, two LBT bandwidths are for illustration purpose only, and this example can be extended to when the scheduled UL transmission(s) span over more than two LBT bandwidths as well. It can also be applied to when the LBT bandwidths are contiguous to each other or have gaps in between different LBT bandwidths. In addition, it can be applied to when the aforementioned embodiments and/or examples may be applied by the gNB in sharing the UE-initiated COT of different LBT bandwidths.

In one example, the maximum duration of the COT that can be shared by the gNB from associated UEs can be independently chosen at each LBT bandwidth, wherein the maximum COT duration that can be shared by the gNB on each LBT bandwidth is the remaining UE-initiated COT on this LBT bandwidth, after a successful LBT attempt by the gNB at the UL to DL switching point.

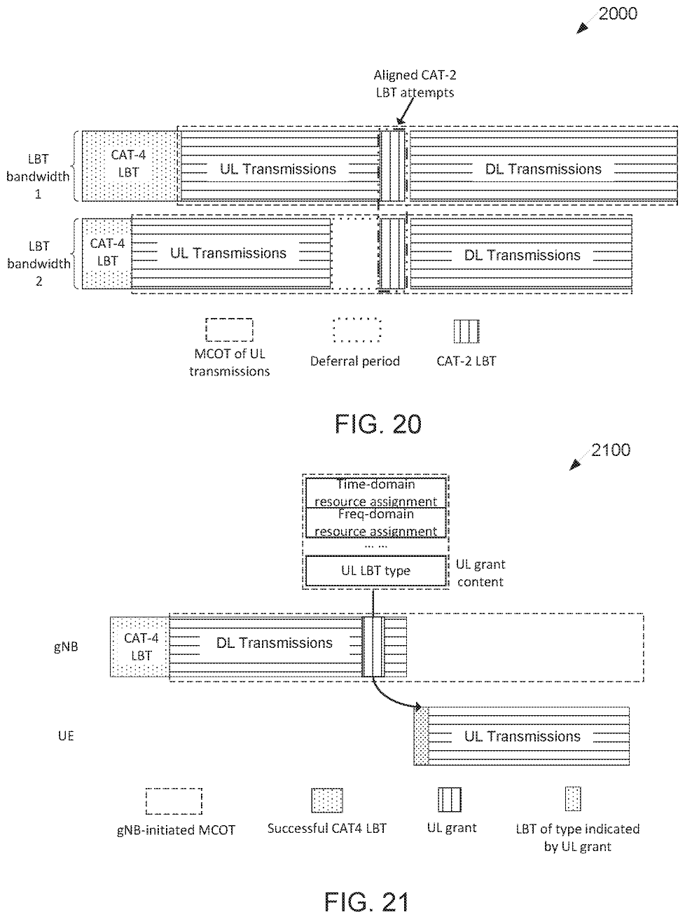

FIG. 20 illustrates yet another example UL transmission with two LBT bandwidth 2000 according to embodiments of the present disclosure. An embodiment of the UL transmission with two LBT bandwidth 2000 shown in FIG. 20 is for illustration only. One or more of the components illustrated in FIG. 20 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 20, the UL transmission on LBT bandwidth 1 starts later than the UL transmission on LBT bandwidth 2 due to different CAT-4 LBT operation, and thus the MCOT of LBT bandwidth 1 finishes later than the MCOT of LBT bandwidth 2. The gNB applies a self-deferral period at LBT bandwidth 2 to align the CAT-2 LBT attempt position, and that the gNB has passed both CAT-2 operations. According to the aforementioned embodiments and/or examples, DL transmissions by the gNB on LBT bandwidth 1 and LBT bandwidth 2 can be continued until the end of the MCOT on LBT bandwidth 1 and LBT bandwidth 2 respectively.

The example as illustrated in FIG. 20, two LBT bandwidths are for illustration purpose only, and this example can be extended to when the scheduled UL transmission(s) span over more than two LBT bandwidths as well. It can also be applied to when the LBT bandwidths are contiguous to each other or have gaps in between different LBT bandwidths. In addition, it can be applied to when one of the aforementioned examples and/or embodiments may be applied by the gNB in sharing the UE-initiated COT of different LBT bandwidths.

In one example, the aforementioned embodiments and/or examples can be combined regarding the frequency and time domain resources that the gNB can be shared with each UE-initiated COT.

In one embodiment, signaling and indication scheme of the LBT type are provided to grant UL transmissions in NR-U.

In one example, the LBT type for granting UL transmissions in NR-U can include: CAT-4 LBT, wherein each CAT-4 LBT type can have a corresponding LBT priority class value. For example, there can be a total of 4 LBT priority class values, and the lower the priority class value, the higher the channel access priority. The CAT-4 LBT can be used by the UE to obtain a UE-initiated COT; CAT-2 LBT of 25 μs duration. This can be used when the gap from the start of the UL transmission to the end of previous transmission is at least 25 μs, and the UL transmission can be shared within a COT obtained through CAT-4 LBT; CAT-2 LBT of 16 μs duration. This can be used when the gap from the start of the UL transmission to the end of previous transmission is 16 μs, and the UL transmission can be shared within a COT obtained through CAT-4 LBT; and CAT-1 LBT with immediate transmission. This can be used when the gap from the start of the UL transmission to the end of previous transmission is less than 16 μs, and the UL transmission can be shared within a COT obtained through CAT-4 LBT.

In one example, the LBT type for an UL transmission can be indicated dynamically through the UL grant scheduling/configuring the UL transmission.

FIG. 21 illustrates an example indication and signaling for LBT type 2100 according to embodiments of the present disclosure. An embodiment of the indication and signaling for LBT type 2100 shown in FIG. 21 is for illustration only. One or more of the components illustrated in FIG. 21 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 21, FIG. 21 provides a high-level illustration when the LBT type for scheduled UL transmission is indicated by a corresponding UL grant.

In one example, the UL grant refers to the PDCCH that can schedule or configure an UL transmission.

In one sub-example, the UL grant can refer to PDCCH of DCI format 0_0 or DCI format 0_1, which directly schedules a PUSCH uplink transmission.

In one sub-example, the UL grant can also refer to PDCCH of DCI format 1_0 or DCI format 1_1. For instance, such UL grant configures an uplink transmission (e.g., PUCCH) that contains HARQ-ACK feedback corresponding to the PDSCH transmission scheduled by the PDCCH

In one example, the UL grant/PDCCH can have a LBT type field to indicate one of the CAT-1 LBT, 16 μs CAT-2 LBT, 25 μs CAT-2 LBT, CAT-4 LBT with priority class/CAPC value 1, CAT-4 LBT with priority class/CAPC value 2, CAT-4 LBT with priority class/CAPC value 3, and CAT-4 LBT with priority class/CAPC value 4.

In one sub-example, the number of bits for the LBT type field in the UL grant requires 3 bits.

In one example, the UL grant/PDCCH can have a LBT type field of L bits to indicate one of the LBT types in set S, wherein S is a subset of {CAT-1 LBT, 16 μs CAT-2 LBT, 25 μs CAT-2 LBT, CAT-4 LBT} and L=┌log₂(|S|)┐.

In one sub-example, the UL grant/PDCCH can have an LBT type field of 2 bits to indicate one of the CAT-1 LBT, 16 μs CAT-2 LBT, 25 μs CAT-2 LBT.

In another sub-example, the UL grant/PDCCH can have an LBT type field of 1 bit to indicate one of the CAT-1 LBT, 25 μs CAT-2 LBT.

In another sub-example, the UL grant/PDCCH can have an LBT type field of 2 bits to indicate one of the CAT-1 LBT, 25 μs CAT-2 LBT, and CAT-4 LBT.

In one example, the LBT priority class/CAPC value corresponding to the UL transmission scheduled/configured by the gNB can be determined by the UE without explicit indication by the UL grant/PDCCH.

In one sub-example, the LBT priority class/CAPC value corresponding to the UL transmission can be determined from the QoS class identifier (QCI) corresponding to the UL transmission, wherein the QCI can be obtained from higher layer configuration/parameter (i.e., bearer type).

In one sub-example, a fixed LBT priority class/CAPC value can be associated with certain the type of UL transmissions scheduled/configured by UL grant/PDCCH. For instance, the LBT priority class/CAPC value associated with PUCCH transmission can be 1, i.e., the highest priority.

In one example, the UL grant/PDCCH can have a field of 2 bits to explicitly indicate one of four LBT priority class/CAPC values.

In one sub-example, when CAT-4 LBT is configured for UL transmission, the CAT-4 LBT priority class (or CAPC equivalently) corresponding to the UL transmission can be configured through another field in the UL grant/PDCCH with 2 bits to indicate one of the four LBT priority class/CAPC values.

In another sub-example, the CAT-4 LBT priority class value/CAPC field corresponding to the UL transmission can be configured regardless of whether CAT-4 LBT for the UL transmission is configured or not.

In one instance, when the CAT-4 LBT is configured for the UL transmission, the CAT-4 LBT priority class value (or CAPC equivalently) refers to the CAPC of the CAT-4 LBT for the UL transmission.

In another instance, when the CAT-4 LBT is not configured for the UL transmission, the CAT-4 LBT priority class/CAPC value can refer to the CAT-4 LBT priority class value of the current COT that a UE can be shared with. In addition, the UE can use the CAT-4 LBT priority class value information to derive the duration of the COT that a scheduled UL transmission can share with.

In yet another instance, when the CAT-4 LBT is not configured for the UL transmission, the CAT-4 LBT priority class/CAPC value can refer to the CAT-4 LBT priority class value associated with the UL transmission scheduled/configured by the UL grant/PDCCH.

In another sub-example, when CAT-4 LBT is configured for UL transmission, the CAT-4 LBT priority class/CAPC value can be indicated by the higher layer parameter (e.g., RRC layer); wherein each type of UL signal/channel can be configured with a corresponding CAT-4 LBT priority class value by the higher layer parameter.

In yet another sub-example, when CAT-4 LBT is configured for UL transmission, the CAT-4 LBT priority class/CAPC value can be fixed in the specification, wherein each type of UL signal/channel can be associated with a fixed CAT-4 LBT priority class value when CAT-4 LBT is configured. For instance, for PUCCH, PRACH, PUSCH containing uplink control information (UCI), a CAT-4 LBT with the highest LBT priority (i.e., lowest CAT-4 LBT priority class value) can be used.

In yet another sub-example, one or multiple of the sub-examples can be used in combination; wherein the CAT-4 LBT priority class value configured by UL grant (if any), can override the configuration of CAT-4 LBT priority class value configured by higher layer parameter or fixed in the spec; and the configuration of CAT-4 LBT priority class value configured by higher layer parameter can override the configuration fixed in the spec.

In one example, the UL grant can have one LBT type field of 1 bit to indicate whether the configured LBT type is CAT-4 LBT or not.

In one sub-example, this field can also be interpreted as an indicator field to indicate if the scheduled/configured PUSCH is within the gNB MCOT or not. For instance, CAT-4 LBT can be used if the PUSCH is outside the gNB MCOT; otherwise CAT-1/CAT-2 LBT can be used.

In one sub-example, an additional DCI field of 2 bits can be further configured to indicate the specific LBT class type, wherein: If CAT-4 LBT is configured, the additional field of 2 bits can indicate one of the 4 LBT priority class values; and If CAT-4 LBT is not configured, the additional field of 2 bits can indicate one of the CAT-1 LBT, 16 μs CAT-2 LBT, and 25 μs CAT-2 LBT.

In one example, the UL grant/PDCCH can have an LBT type field to indicate the LBT type, wherein the supported LBT types to be indicated in the UL grant/PDCCH can be configured or determined from higher layer parameters.

In one sub-example, the number of bits for the LBT type field is ┌log₂(L)┐ wherein L is the number of LBT types configured by higher layer parameter.

In one instance, the higher layer parameter can configure the supported LBT types to be CAT-1 LBT, and 25 μs LBT and 16 μs LBT, and the LBT type field can use 2 bits to indicate one of the supported LBT types.

In another instance, the higher layer parameter can configure the supported LBT types to be CAT-1 LBT, and 25 μs LBT, and the LBT type field can use 1 bit to indicate one of the supported LBT types.

In another sub-example, this example can be applied when different supported LBT types can be configured by higher layer parameter for LBE NR-U and FBE NR-U.

In one instance, the higher layer parameter can configure the supported LBT types for LBE NR-U to be all or a subset of CAT-1 LBT, 16 μs LBT, 25 μs LBT, and CAT-4 LBT.

In another instance, the higher layer parameter can configure the supported LBT types for FBE NR-U to be all or a subset of CAT-1 LBT, 16 μs LBT, 25 μs LBT.

In another instance, the higher layer parameter can configure the current NR-U system is operating in FBE or NR-U mode.

In one example, the starting and length indicator value (SLIV) indicated in the UL grant/PDCCH for the scheduled/configured UL transmission can be interpreted as the starting symbol for the LBT operation before the UL transmission, and the UL transmission can start after the LBT operation is finished. In one sub-example, the UL transmission may be punctured in the first symbol after the LBT operation.

In one example, the starting and length indicator value (SLIV) indicated in the UL grant/PDCCH for the scheduled/configured UL transmission can be interpreted as the starting symbol for the UL transmission, and the LBT operation is performed before the indicated start of the scheduled UL transmission.

In one example, the LBT type and/or LBT parameter for UL transmission can be semi-statically configured through higher layer parameter.

In one example, the higher layer parameter (e.g., RRC layer) can configure the CAT-4 LBT as the default LBT type.

In one example, the higher layer parameter can configure the corresponding default LBT priority class value for different UL signal/channel when CAT-4 LBT is configured.

In one sub-example, the LBT priority class value for UL signal/channel such as PRACH, regular PUSCH, SRS, PUCCH, etc. can be configured through RRC information element BWP-UplinkDedicated.

In one sub-example, a combination of the aforementioned examples and/or embodiments is provided, wherein the CAT-4 LBT can be configured by DCI as the LBT type, the CAT-4 LBT priority class value can be configured by the higher layer parameter.

In one example, the higher layer parameter can configure the CAT-2 LBT as the default LBT type.

In one example, the higher layer parameter can configure a default CAT-2 LBT type from 16 μs CAT-2 LBT and 25 μs CAT-2 LBT when CAT-2 LBT is used.

In one sub-example, a combination of the aforementioned embodiments and/or examples is provided, wherein the CAT-2 LBT can be configured by DCI as the LBT type, the 16 μs CAT-2 LBT or 25 μs CAT-2 LBT can be configured by the higher layer parameter.

In one example, the higher layer parameter can configure a default non-CAT 4 LBT type from CAT-1 LBT, 16 μs CAT-2 LBT and 25 μs CAT-2 LBT when CAT-4 LBT is not configured.

In one sub-example, a combination of the aforementioned embodiments and/or example is provided, wherein the DCI configures that the LBT type is not CAT-4 LBT, one of the CAT-1 LBT, 16 μs CAT-2 LBT or 25 μs CAT-2 LBT can be configured by the higher layer parameter.

In one example, the higher layer parameter can configure a subset of LBT types from {CAT-1 LBT, 16 μs CAT-2 LBT, 25 μs CAT-2 LBT, CAT-4 LBT}.

In another sub-example, this example can be applied when different supported LBT types can be configured for LBE NR-U and FBE NR-U respectively.

In one instance, the higher layer parameter can configure the supported LBT types for LBE NR-U to be all or a subset of CAT-1 LBT, 16 μs LBT, 25 μs LBT, and CAT-4 LBT.

In another instance, the higher layer parameter can configure the supported LBT types for FBE NR-U to be all or a subset of CAT-1 LBT, 16 μs LBT, 25 μs LBT.

In another instance, the higher layer parameter can configure the current NR-U system is operating in FBE or NR-U mode.

In one example, the higher layer parameter can configure a subset of LBT types from {CAT-1 LBT, 16 μs CAT-2 LBT, 25 μs CAT-2 LBT, CAT-4 LBT with CAPC value 1, CAT-4 LBT with CAPC value 2, CAT-4 LBT with CAPC value 3, CAT-4 LBT with CAPC value 4}.

In one example, the higher layer parameter (e.g., RRC) configured LBT type can be overridden by DCI configured LBT type through dynamic indication.

In one example, the starting and length indicator value (SLIV) indicated in the UL grant for the scheduled UL transmission can be interpreted as the starting symbol for the LBT operation before the UL transmission, and the UL transmission can start after the LBT operation is finished.

In one example, the starting and length indicator value (SLIV) indicated in the UL grant for the scheduled UL transmission can be interpreted as the starting symbol for the UL transmission, and the LBT operation is performed before the indicated start of the scheduled UL transmission.

In one embodiment, the LBT type and/or LBT parameter for UL transmission can be fixed by specification.

In one example, CAT-4 LBT and corresponding LBT priority class value can be fixed in specification for certain UL signals/channels. For instance, the UL signals/channels (e.g., UCI transmission in PUSCH, the standalone PRACH) can be subject to CAT-4 LBT by default, and the corresponding LBT priority class value can be fixed in the spec.

In another example, the fixed configuration of LBT type by specification can be overridden by semi-static configuration or dynamic configuration.

In yet another example, the starting and length indicator value (SLIV) indicated in the UL grant for the scheduled UL transmission can be interpreted as the starting symbol for the LBT operation before the UL transmission, and the UL transmission can start after the LBT operation is finished.

In one example, the starting and length indicator value (SLIV) indicated in the UL grant for the scheduled UL transmission can be interpreted as the starting symbol for the UL transmission, and the LBT operation is performed before the indicated start of the scheduled UL transmission.

In one embodiment, the LBT type can be obtained by the UE through implicit indication, wherein the UE can determine LBT type implicitly (i.e., without explicit LBT type field in the DCI) through configurations by DCI and/or higher layer parameter.

In one example, the configurations by DCI and/or higher layer parameter that can facilitate UE implicit derivation of a LBT type can include the gNB COT duration and a gNB COT starting position, or the gNB COT ending position corresponding the gNB COT wherein UL grant is received by the UE.

In one sub-example, the gNB COT starting position and gNB COT duration, or the gNB COT ending position can be indicated through one or multiple of GC-PDCCH, a UE specific PDCCH, DM-RS, higher layer parameter(s).

In another sub-example, based on the gNB COT duration and/or the gNB COT ending position, a UE can determine if the starting position of UL transmission scheduled by the UL grant is within the current gNB COT or not, and that if the starting position of the scheduled UL transmission is outside the gNB COT, CAT-4 needs to be used.

In another sub-example, based on the gNB COT duration and/or the gNB COT ending position, a UE can determine if the starting position of UL transmission scheduled by the UL grant is within the current gNB COT or not, and that CAT-1 LBT or CAT-2 LBT can be used if the starting position of the scheduled UL transmission is inside the gNB COT, wherein the specific LBT type (CAT-1 LBT, 16 μs CAT-2 LBT or 25 μs CAT-2 LBT) can be either indicated explicitly by DCI or derived implicitly by the UE through other configuration information according to the aforementioned embodiments and/or examples.

In one example, the configurations by DCI and/or higher layer parameter that can facilitate UE implicit derivation of an LBT type can include the gNB COT structure, which configures the slot format for each slot within the gNB-initiated COT that contains the UL grant.

In one sub-example, the COT structure can be obtained by the UE through group common (GC)-PDCCH.

In one sub-example, the COT structure can be indicated by the slot format indication (SFI) for each slot within the COT, wherein the SFI may indicate the symbol within a slot of the COT is DL, UL or flexible.

In another sub-example, a UE can determine the gap duration from the end of the previous DL transmission within the gNB-initiated COT to the beginning of a scheduled UL transmission based on the last DL symbol position before the starting position of the scheduled UL transmission, which can be obtained through the gNB COT structure, as well as the UL TA value configured by DCI and/or higher layer parameter.

In one example, the configurations by DCI and/or higher layer parameter that can facilitate UE implicit derivation of an LBT type can include the UL grant/PDCCH that schedules the UL transmission.

In one sub-example, the UL grant/PDCCH can indicate to the UE the starting position of the UL transmission.

In another sub-example, the UL grant can indicate the duration of the scheduled UL transmission. In one instance, if the scheduled UL transmission is within the gNB-initiated COT of the UL grant, and the duration of the scheduled UL transmission is longer than a certain threshold (e.g., 584 μs), CAT-2 LBT needs to be applied for UL transmission; otherwise CAT-1 LBT can also be applied in addition to CAT-2 LBT for the UL transmission.

In another sub-example, a UE can be indicated through the UL grant a way to create a gap of certain desired duration, the UE can derive from the desired gap duration the corresponding LBT type. For instance, the LBT type can be CAT-1 LBT, 16 μs CAT-2 LBT, and 25 μs CAT-2 LBT when the desired gap duration is less than 16 μs, 16 μs, (at least) 25 μs respectively.

In another sub-example, the UL grant can have an indicator field to indicate if the scheduled/configured PUSCH is within the current gNB MCOT or not, such that CAT-4 LBT needs to applied if PUSCH is outside MCOT, otherwise CAT-1/CAT-2 LBT can be used.

In one example, it can be up to UE implementation to decide the LBT type (e.g., 16/25 μs CAT-2 LBT, CAT-1 LBT) if the scheduled UL transmission can share the gNB-initiated COT containing the UL grant.

In one sub-example, a UE can always use 25 μs as the baseline CAT-2 LBT option.

In another sub-example, if the UE is indicated in UL grant/PDCCH to use CAT-4 LBT to initiate the UL transmission, but the UE can determine the scheduled/configured UL transmission is within a gNB-initiated COT (possibly different from the gNB COT that contains the UL grant/PDCCH), the UE can utilize one of the 25 μs CAT-2 LBT, 16 μs CAT-2 LBT, and CAT-1 LBT.

In another sub-example, if the UE switches from using CAT-4 LBT as indicated in UL grant/PDCCH to using one of the 25 μs CAT-2 LBT, 16 μs CAT-2 LBT, and CAT-1 LBT by sharing the gNB COT, the LBT priority class/CAPC value associated with the UL transmission needs to be no less (i.e., less or equally prioritized) than the LBT priority class/CAPC value that a gNB used in obtaining the gNB COT.

In one example, if the UE is indicated in UL grant/PDCCH to use CAT-1/CAT-2 LBT to initiate the UL transmission, but the UE can determine the scheduled/configured UL transmission is outside a gNB-initiated COT (possibly different from the gNB COT that contains the UL grant/PDCCH), the UE can utilize CAT-4 LBT to initiate the COT.

In one example, the starting and length indicator value (SLIV) indicated in the UL grant for the scheduled UL transmission can be interpreted as the starting symbol for the LBT operation before the UL transmission, and the UL transmission can start after the LBT operation is finished.

In one example, the starting and length indicator value (SLIV) indicated in the UL grant for the scheduled UL transmission can be interpreted as the starting symbol for the UL transmission, and the LBT operation is performed before the indicated start of the scheduled UL transmission.

In one example, the aforementioned examples and/or embodiments may be combined.

In one sub-example, when multiple starting positions for the UE is configured, then: for the first possible starting position, the UE can use the LBT type configured by the UL grant/PDCCH according to the one of the aforementioned embodiments and/or examples; for instance, CAT-1 LBT or 16 μs CAT-2 LBT or 25 μs CAT-2 LBT (if configured) can be used for the first possible starting position if configured; for the first possible starting position, the UE can determine the LBT type; and for the following possible starting positions, the UE can use LBT type configured by the UL grant/PDCCH; or the UE can determine the LBT type such that a 25 μs CAT-2 LBT can be used if the PUSCH is within a gNB-initiated COT, otherwise CAT-4 LBT can be used.

In another sub-example, when multiple TTI scheduling for the UE is configured, then: for the first scheduled TTI, the UE can use the LBT type configured by the UL grant/PDCCH according to the aforementioned embodiments and/or examples; for instance, CAT-1 LBT or 16 μs CAT-2 LBT or 25 μs CAT-2 LBT (if configured) can be used for the first scheduled TTI if configured; for the first scheduled TTI, the UE can determine the LBT type; and for the following scheduled TTIs, the UE can use LBT type configured by the UL grant/PDCCH; or the UE can determine the LBT type such that a 25 μs CAT-2 LBT can be used if the PUSCH is within a gNB-initiated COT, otherwise CAT-4 LBT can be used.

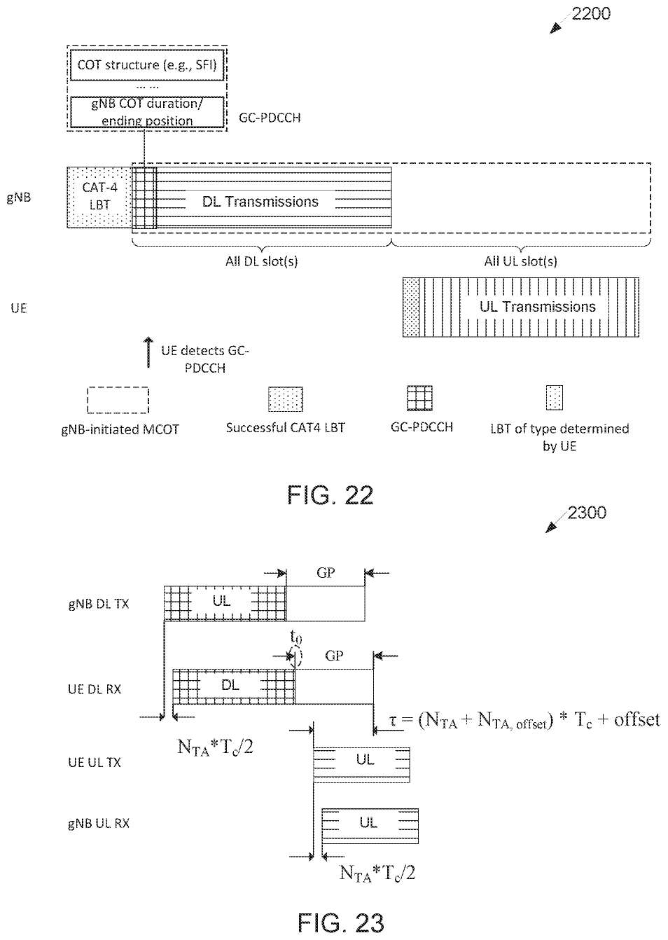

FIG. 22 illustrates another example indication and signaling for LBT type 2200 according to embodiments of the present disclosure. An embodiment of the indication and signaling for LBT type 2200 shown in FIG. 22 is for illustration only. One or more of the components illustrated in FIG. 22 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 22, the UE can determine a UL transmission is within the current gNB-initiated COT after detecting the GC-PDCCH, and the UE can choose a corresponding UL LBT type according to the COT structure indicated in the GC-PDCCH.

In one embodiment, a gap of specific duration and/or the method to create the gap of the specific duration can be configured, wherein the gap is from the end of the previous DL transmission to the start of the scheduled UL transmission, such that the UL transmission can share the gNB-initiated COT that contains the scheduling UL grant.

FIG. 23 illustrates an example gap duration 2300 according to embodiments of the present disclosure. An embodiment of the gap duration 2300 shown in FIG. 23 is for illustration only. One or more of the components illustrated in FIG. 23 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 23, the timing relation is provided at both gNB side and a UE side for DL to UL switching, wherein GP is the guard period with N>=0 OFDM symbols for DL to UL switching. In addition, the uplink NR-U transmission for a UE takes place before the start of the corresponding downlink NR-U slot at the UE, as given by:

τ=(N_{TA}+N_{TA,offset})*T_{c}+offset) equation (1)

where T_{c}=1/(4096*480 kHz), N_{TA}*T_{c} represents the timing advance value of the UE (e.g., round trip delay between the gNB and the UE), which can be obtained through random access procedure; N_{TA, offset}*T_{c} represents the guard period for the UL to DL switching time, which is fixed in spec as 0 for FDD, 25560 T_{c}=13 μs for TDD in FR1 and 13763 T_{c}=7 μs for TDD in FR2; and offset represents any additional offset configured by the DCI to create a specific gap duration τ.

In one example, a gap of specific duration can be created through adjusting the timing advance value for a UE UL transmission.

In one sub-example, when the gap duration of a specific duration is created by adjusting the timing advance value for the UE UL transmission, the indication can be through configuring an additional TA offset value (i.e., offset in equation (1)), which is applied in addition to the legacy TA value (i.e., round trip delay between the gNB and the UE) obtained through random access procedure (i.e., N_{TA}*T_{c} in equation (1)), and optionally the gap for UL to DL switching (i.e., N_{TA, offset}*T_{c} term of equation (1) if this gap is configured.

In another sub-example, when the gap duration of a specific duration is created by adjusting the timing advance value for a UE UL transmission, the indication can be through configuring a new TA offset value (i.e., offset+N_{TA}*T_{c} in equation (1)), which can override the legacy TA value (i.e., round trip delay between the gNB and the UE) obtained through random access procedure (i.e., N_{TA}*T_{c} in Eq. (1)).

In one embodiment, a gap of specific duration can be created through extending the cyclic prefix (CP) length of the UE UL transmission.

In one sub-example, when the gap of specific duration is created by extending the CP length of UE UL transmission, the indication can be through configuring a value for the extended portion of the CP (i.e., offset term in equation (1)) of the first symbol of UL transmission, which is applied in addition to the default CP duration of the first symbol of UL transmission.

In another sub-example, when the gap of specific duration is created by extending the CP length of UE UL transmission, the indication can be through configuring a value for the extended CP length of the first UL symbol of UL transmission, which can override the default CP duration of the first symbol of UL transmission.

In one example, a gap of specific duration can be created by truncating/puncturing all or partial of the last DL/UL symbol(s) before the start of the UE UL transmission.

In one sub-example, the gap creation method in this example can be indicated either explicitly to the UE through one of the UL grant or higher layer parameter.

In another sub-example, the gap duration of this example does not need to be explicitly indicated to the UE. For instance, the desired gap duration can be created by the gNB, and the UE can follow the UL grant to perform LBT of an indicated LBT type and start UL transmission according to the UL grant after LBT is passed.

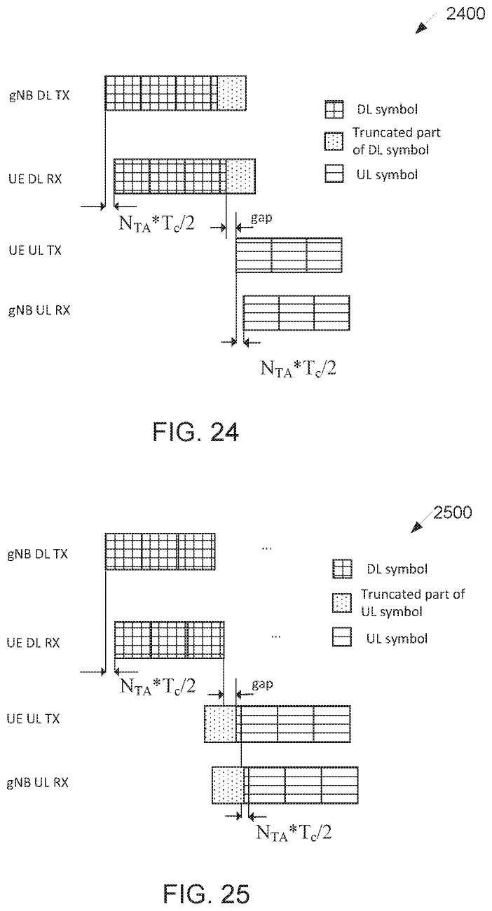

FIG. 24 illustrates another example gap duration 2400 according to embodiments of the present disclosure. An embodiment of the gap duration 2400 shown in FIG. 24 is for illustration only. One or more of the components illustrated in FIG. 24 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 24, the gap of desired duration can be created by the gNB through puncturing/truncating the DL symbols.

In one embodiment, a gap of specific duration can be created by truncating/puncturing all or partial of the first or first few symbol(s) of the UE UL transmission.

In one sub-example, the gap creation method in this example can be indicated either explicitly to the UE through one of the UL grant or higher layer parameter.

In another sub-example, the desired gap duration can be created by indicating to the UE the duration value to be truncated/punctured from the start of the UE UL transmission through UL grant or higher layer parameter.

In another sub-example, the desired gap duration can be created by indicating to the UE the desired gap duration, and the UE can derive the corresponding duration to be truncated/punctured according to the configuration of the start of UE UL transmission and LBT type, which can be obtained through UL grant or higher layer parameter.

FIG. 25 illustrates yet another example gap duration 2500 according to embodiments of the present disclosure. An embodiment of the example gap duration 2500 shown in FIG. 25 is for illustration only. One or more of the components illustrated in FIG. 25 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 25, the gap of desired duration can be created by the UE through puncturing/truncating the first UL symbol(s).

In one example, the method for creating the gap of a specific duration can be indicated explicitly through a field of size n (n>=1) bits in the UL grant.

In one sub-example, the number of bits n can be n=1, wherein this field can indicate one of the CP extensions or adjusting TA value by the UE.

In another sub-example, the number of bits n can be n=2, wherein this field can indicate one of the CP extensions, adjusting TA value by the UE, shorten the UL transmission duration, and no gap creation.

In another sub-example, the number of bits n can be n=2, wherein this field can indicate one of the CP extensions, adjusting TA value by the UE, shorten the UL transmission duration, and shorten the previous DL transmission duration.

In one example, the method for creating the gap of a specific duration can be configured semi-statically through higher layer parameter(s).

In one sub-example, the higher layer parameter can configure one of the adjusting TA values, CP extension, shortening of UL transmission, or shortening of DL transmission as the method to create a gap of specific duration.

In one example, the method for creating the gap of a specific duration can be fixed in the specification, wherein one of the adjusting TA value, CP extension, shortening of UL transmission, or shortening of DL transmission can be fixed as the method to create a gap of specific duration.

In one example, the method for creating the gap of a specific duration can be implicitly determined by the UE, wherein one of the CP extension, adjusting TA value by the UE, shorten the UL transmission duration, and no gap creation can be used by the UE.

In one example, the method for creating the gap of a specific duration can be through two level indication, wherein the higher layer parameter can configure n (n>=1) gap creation method from the adjusting TA value, CP extension, shortening of UL transmission, or shortening of DL transmission as the method to create a gap of specific duration; and a DCI field of └log₂(n)┘ bits to indicate the chosen gap creation method.

In one example, for each method to create the gap of a specific duration, the granularity (unit) in creating the gap of the specific duration of the method can be indicated.

In one sub-example, the granularity can be one or an integer multiple of T_{c}=1/(4096*480 kHz) or Tₛ=1/(2048*15 kHz).

In another sub-example, the granularity can be m/n μs, wherein m and n are integer numbers.

In another sub-example, the granularity can be fixed in the specification. In one instance, each gap creation method can be a fixed corresponding granularity.

In another sub-example, the granularity can be configured by the higher layer parameter (e.g., in RRC parameter).

In another sub-example, the granularity can be configured by UL grant.

In another sub-example, the configured granularity can depend on the subcarrier spacing, such that the granularity for SCS1 is larger than that of SCS2 if SCS1<SCS2.

In one example, the actual offset value to create the gap can be explicitly indicated by the UL grant through a DCI field.

In one sub-example, if the granularity of the offset is 1 μs, the DCI field can have 5 bits to indicate an offset value of up to 1 OFDM symbol of 30 kHz SCS; and the DCI field can have 7 bits to indicate an offset value of up to 1 OFDM symbol of 15 kHz SCS.

In one example, the actual offset value to create the gap can be implicitly derived by the UE through the configured gap creation method and the configured LBT type (e.g., through one of the aforementioned embodiments and/or examples); such that the actual offset value can ensure that: the gap duration is at most 16 μs if CAT-1 LBT is configured; the gap duration is 16 μs if CAT-2 LBT of 16 μs is configured; and the gap duration is (at least) 25 μs if CAT-2 LBT of 25 μs is configured.

In one example, when the actual offset value to create the gap is explicitly indicated and a gap creation method is configured, the LBT type can be inferred by the UE without explicit indication based on the gap duration (derived from the offset value and gap duration method), wherein: a UE can use CAT-1 LBT if the gap duration is at most 16 μs; a UE can use CAT-2 LBT of 16 μs if the gap duration is 16 μs; and a UE can use CAT-2 LBT of 25 μs if the gap duration is (at least) 25 μs.

In one example, the gap creation method in the aforementioned embodiments and examples, can be applied to the gap creation for UL to UL gap as well.

In one sub-example, the gap can be the gap duration between the end of the last UL symbol of a previous UL transmission (e.g., scheduled UL transmission of other UEs) to the start of the scheduled UL transmission of the current UE. For instance, the end of the last UL symbol of a previous UL transmission can be obtained according to the structure of the current COT containing the UL grant.

In one example, if a CP extension is used as the method to create the gap of expected duration, the extension can be performed with respect to the starting symbol indicated by the starting and length indicator value (SLIV) of the UL grant.

In one embodiment, a maximum duration on the UL transmission to share the gNB-initiated COT following a successful UE CAT-1 LBT or CAT-2 LBT can be introduced.

In one example, the maximum duration of UL transmission following CAT-1 LBT can be 584 μs.

In one example, the maximum duration of UL transmission following CAT-2 LBT can have no limit. For instance, this can be applied when the CAT-2 LBT has two CCA checks within the CAT-2 LBT.

In one example, the maximum duration of UL transmission following CAT-2 LBT can have a limit. For instance, this can be applied if the CAT-2 LBT has one CCA checks within the CAT-2 LBT. In another instance, this limit can be N ms (N>=1).

In one embodiment, COT sharing is provided between a gNB-initiated COT and semi-statically configured UL transmission.

In addition to the UL transmissions scheduled by UL grant through DCI, semi-statically configured UL transmission such as configured-grant UL transmission and PRACH can be transmitted without explicit UL grant. This embodiment covers approaches and examples for LBT options of such semi-statically configured UL transmissions.

In one embodiment, in transmitting such semi-statically configured UL transmissions (e.g., CG-UL transmission/PRACH), an NR-U UE performs CAT-4 LBT in obtaining the unlicensed channel as a baseline option.

In one example, the LBT priority class value of the CAT-4 LBT for the semi-statically configured UL transmission can be fixed by the specification.

In one sub-example, different type of semi-statically configured UL transmission can have different fixed CAT-4 LBT priority class value respectively.

In one example, the LBT priority class value of the CAT-4 LBT for the semi-statically configured UL transmission can be configured by higher layer parameter (e.g., RRC parameter).

In one sub-example, different type of semi-statically configured UL transmission can be configured with different CAT-4 LBT priority class value respectively.

In one embodiment, for the semi-static configured UL transmissions (e.g., CG-UL transmission/PRACH), a UE can implicitly infer that CAT-1 LBT or CAT-2 LBT can be used through detection of a downlink transmission burst of a serving gNB and derivation of the COT duration and/or COT structure information corresponding to the downlink transmission burst.

In one example, a UE can detect a downlink transmission burst of a serving gNB through detecting the DM-RS of the group-common (GC)-PDCCH and/or the GC-PDCCH.

In one example, upon detection of a downlink transmission burst, a UE can determine the COT duration/structure through GC-PDCCH.

In one example, a UE can use CAT-1 LBT or CAT-2 LBT for semi-static UL transmissions if the UE can determine the entire semi-static UL transmission is within the COT of the downlink transmission burst of a serving gNB.

In one example, a UE can use CAT-1 LBT or CAT-2 LBT for semi-static UL transmissions if the UE can determine the starting position of the semi-static UL transmission is within the COT of the downlink transmission burst of a serving gNB, while the portion of the semi-static UL transmission falling outside the COT of the downlink transmission burst (if any) may be punctured.

In one example, a UE can use CAT-1 LBT or CAT-2 LBT for semi-static UL transmissions if the UE can determine the entire semi-static UL transmission is within the COT of the downlink transmission burst of a serving gNB, and that the COT structure indicates the remaining COT since the start of the semi-static UL transmission is all UL symbols, or all UL/flexible symbols.

In one example, a UE can use CAT-1 LBT or CAT-2 LBT for semi-static UL transmissions if the UE can determine the starting symbol of a semi-static UL transmission is within the COT of the downlink transmission burst of a serving gNB, and that the UE can utilize the continuous portion of this gNB-initiated COT which is configured as UL or UL/flexible since the starting symbol of the semi-static UL transmission.

In one sub-example, the portion of the semi-static UL transmission that falls outside the gNB-initiated COT can be punctured.

In another sub-example, the portion of the semi-static UL transmission that comes after the first symbol that is not UL or UL/flexible, wherein the symbol belongs to the overlapping portion of the gNB-initiated COT and the semi-static UL, can be punctured.

In one example, the default CAT-4 LBT of the semi-statically configured UL transmission is provided as detailed in the aforementioned embodiments and/or examples.

In one example, when a UE can share the gNB-initiated COT, the LBT type for the UE can be fixed to be the 25 μs CAT-2 LBT.

In one example, a UE can determine to use one of the CAT-1 LBT, 16 μs CAT-2 LBT, and 25 μs CAT-2 LBT through determination of the COT structure and the gap duration from the end of the previous DL/UL transmission to the start of the semi-static UL transmission of the UE.

In one sub-example, one of the gap creation method detailed in the aforementioned embodiments can be utilized such that the condition/regulation for the UE to use one of the CAT-1 LBT, 16 μs CAT-2 LBT, and 25 μs CAT-2 LBT can be met.

In one embodiment, a UE can use CAT-1 LBT or CAT-2 LBT for the semi-static configured UL transmissions (e.g., CG-UL transmission/PRACH) through explicit indication from a serving gNB, wherein such explicit indication can be utilized by the gNB if the semi-static UL transmissions can share the current gNB-initiated COT.

In one example, the explicit indication can be through GC-PDCCH, wherein GC-PDCCH can indicate to the associated UEs whose semi-static configured UL transmission is within or can start within the UL or UL/flexible portion of the gNB-initiated COT to use the indicated LBT type for the semi-static UL transmission.

In one example, the explicit indication can be through UE specific PDCCH, wherein the PDCCH can indicate to the UE the LBT type to grant a semi-static UL transmission.

In one example, the explicit indication can be through DL signals such as preamble signal or wake-up signal.

In one example, for type 2 configured grant PUSCH, the explicit indication can be through DCI (e.g., DCI format 0_0, 0_1, 1_0 or 1_1) that activates the CG-PUSCH.

In one embodiment, UL CAT-2 LBT failure is provided within a gNB-initiated COT.

When a UE UL transmission can share with the gNB-initiated COT and the UE UL transmission is subject to CAT-2 LBT, it is possible that CAT-2 LBT is failed due to nearby interference. This embodiment covers how to continue the gNB-initiated COT when the UL CAT-2 LBT has failed for the UL transmission that is configured/scheduled to share the gNB-initiated COT.

In one example, if the CAT-2 LBT has failed for the UL transmission that is configured/scheduled to share the gNB-initiated COT, and that another DL transmission may follow the failed UL transmission within the gNB-initiated COT (i.e., there is an UL to DL switching within the gNB-initiated COT), one of the following examples can be used.

In one example, a gNB has to use CAT-4 LBT in order to continue the DL transmission after the failed UL transmission.

In one example, a gNB can continue the DL transmission after the end of the scheduled failed UL transmission, if the gap from the end of the scheduled UL transmission to the start of the DL transmission is at most 25 μs and the gNB has passed CAT-2 or CAT-1 LBT.

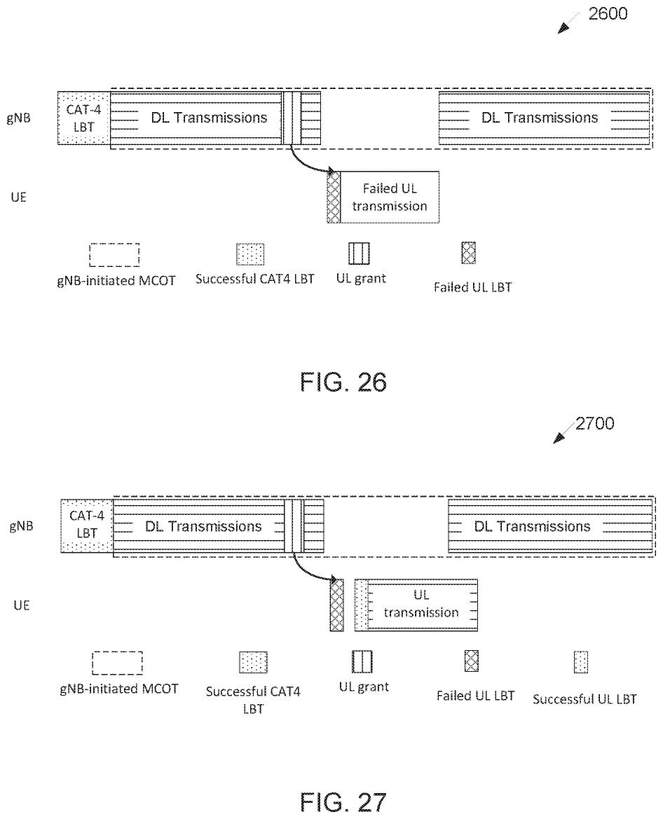

FIG. 26 illustrates an example UL CAT-2 LBT failure 2600 according to embodiments of the present disclosure. An embodiment of the UL CAT-2 LBT failure 2600 shown in FIG. 26 is for illustration only. One or more of the components illustrated in FIG. 26 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 26, the gNB can continue DL transmission after the end of the failed UL transmission subject to CAT-1/CAT-2 LBT at the UL to DL switching point.

In one example, a UE can continue to perform CAT-2 LBT as long as the UE can start the UL transmission within a configured/scheduled UL duration; and the UE can transmit the configured/scheduled UL after a successful CAT-2 LBT, which can be continued until the end of the configured/scheduled UL transmission with potential truncating/puncturing; and a gNB can continue the DL transmission after the end of the configured/scheduled UL transmission subject to CAT-1/CAT-2 LBT.

FIG. 27 illustrates another example UL CAT-2 LBT failure 2700 according to embodiments of the present disclosure. An embodiment of the UL CAT-2 LBT failure 2700 shown in FIG. 27 is for illustration only. One or more of the components illustrated in FIG. 27 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 27, the UE can retry after a failed UL LBT until the UE succeeds or the end of the scheduled UL is reached; and a gNB can continue DL transmission at the UL to DL switching point.

In one example, a gNB can continue the current gNB-initiated COT (subject to CAT-2 LBT at the gNB), if the gNB has not detected the start of the scheduled UL transmission. In one sub-example, the gNB can be subject to a CAT-2 LBT if the gNB continues the COT after not detecting the scheduled UL transmission.

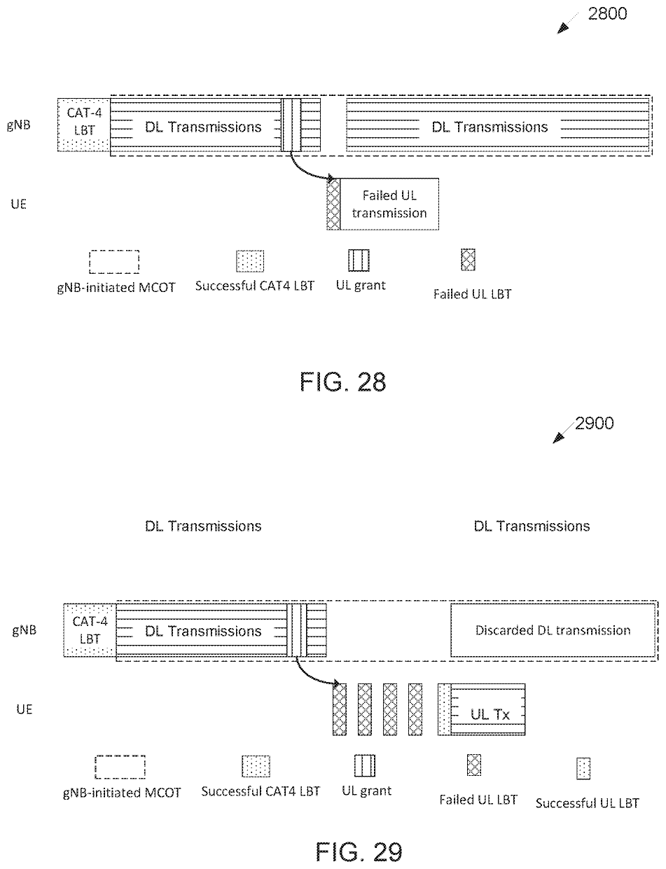

FIG. 28 illustrates yet another example UL CAT-2 LBT failure 2800 according to embodiments of the present disclosure. An embodiment of the UL CAT-2 LBT failure 2800 shown in FIG. 28 is for illustration only. One or more of the components illustrated in FIG. 28 can be implemented in specialized circuitry configured to perform the noted functions or one or more of the components can be implemented by one or more processors executing instructions to perform the noted functions. Other embodiments are used without departing from the scope of the present disclosure.

In one example, if the gNB has not detected the start of the scheduled UL transmission, the gNB can give up continuing a DL transmission and a UE can keep re-attempt the CAT-2 LBT for UL transmission to start within the remaining gNB-initiated COT.

FIG. 29 illustrates yet another example UL CAT-2 LBT failure 2900 according to embodiments of the present disclosure. An embodiment of the UL CAT-2 LBT failure 2900 shown in FIG. 29 is for illustration only. One or more of the components illustrated in FIG. 29 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 29, if the CAT-2 LBT has failed for the UL transmission that is configured/scheduled to share the gNB-initiated COT, and that no DL transmission may follow the failed UL transmission within the gNB-initiated COT (i.e., there is no UL to DL switching within the gNB-initiated COT), one of the following examples can be used.

In one example, a UE can continue to perform CAT-2 LBT, as long as the UL transmission can start within the remaining of the gNB-initiated COT; after the CAT-2 LBT has passed, the UL transmission can have potential truncating/puncturing for the portion that falls outside the gNB-initiated COT.

In one example, a UE can continue to perform CAT-2 LBT, as long as the UL transmission can start within the scheduled UL duration; and after the CAT-2 LBT has passed, the UL transmission can have potential truncating/puncturing for the portion that falls outside the scheduled UL duration.

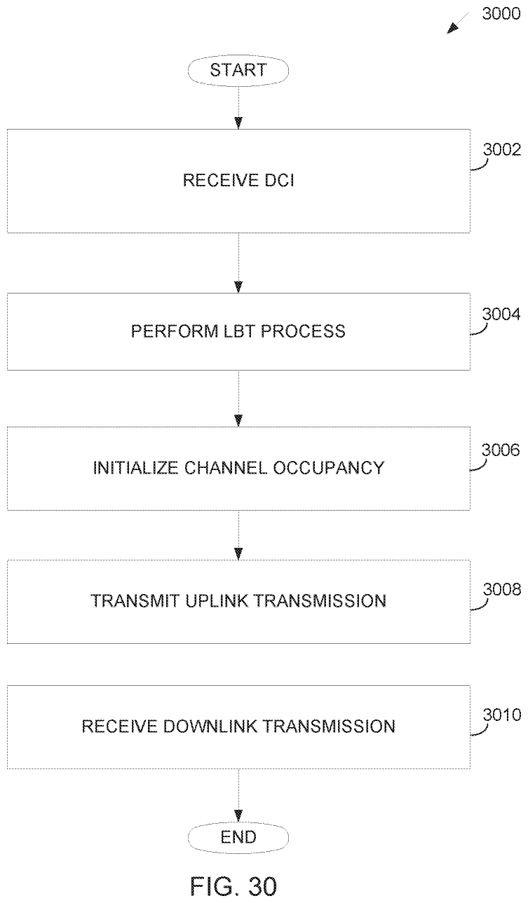

FIG. 30 illustrates a flow chart of a method 3000 for channel occupancy time sharing according to embodiments of the present disclosure, as may be performed by a UE (e.g., 111-116 as illustrated in FIG. 1). An embodiment of the method 3000 shown in FIG. 30 is for illustration only. One or more of the components illustrated in FIG. 30 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 30, the method 3000 begins at step 3002. In step 3002, a UE receives, from a base station (BS), downlink control information (DCI) indicating a type of listen-before-talk (LBT) process for an uplink transmission including a physical uplink shared channel (PUSCH).

In such embodiment, the type of the LBT process comprises at least one of: a first type of the LBT process including a random duration for a channel sensing; a second type of the LBT process including a fixed duration of 25 microseconds for the channel sensing; a third type of the LBT process including a fixed duration of 16 microseconds for the channel sensing; or a fourth type of the LBT process not including a duration for the channel sensing.

Subsequently, the UE in step 3004 performs an LBT process based on the type of the LBT process indicated in the DCI.

Subsequently, the UE in step 3006 initializes, during a channel occupancy time (COT), a channel occupancy comprising a first portion and a second portion that do not overlap each other.

Next, the UE in step 3008 transmits, to the BS, the uplink transmission including the PUSCH in the first portion of the channel occupancy that begins at a starting portion of the channel occupancy.

Finally, the UE in step 3010 receives, from the BS, a downlink transmission in the second portion of the channel occupancy, the downlink transmission comprising at least one of a unicast downlink transmission addressed only to the UE or a non-unicast downlink transmission addressed to a set of UEs including the UE.

In one embodiment, the UE does not receive another unicast downlink transmission not addressed to the UE.

In one embodiment, the UE further includes a gap between the downlink transmission in the second portion of the channel occupancy and the uplink transmission in the first portion of the channel occupancy in the channel occupancy.

In such embodiment, an LBT process of the BS is performed in the gap; and a type of the LBT process is identified based on a duration of the gap.

In such embodiment, the type of the LBT process comprises at least one of: the fourth type of the LBT process when the duration of the gap is smaller than 16 microseconds; or the second or the third type of the LBT process when the duration of the gap is equal to or greater than 16 microseconds.

In one embodiment, the UE further identifies a value of LBT priority class included in the DCI; and receives the DCI including scheduling information for the PUSCH. In such embodiment, the DCI is a DCI format 0_1.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined only by the claims.

What is claimed is:

1. A user equipment (UE) in a wireless communication system supporting a shared spectrum channel access, the UE comprising:
a transceiver configured to receive, from a base station (BS), downlink control information (DCI) indicating a type of listen-before-talk (LBT) process for an uplink transmission including a physical uplink shared channel (PUSCH); and
a processor operably connected to the transceiver, the processor configured to:
perform an LBT process based on the type of the LBT process indicated in the DCI, and
initialize, during a channel occupancy time (COT), a channel occupancy comprising a first portion and a second portion that do not overlap each other,
wherein the transceiver is further configured to:
transmit, to the BS, the uplink transmission including the PUSCH in the first portion of the channel occupancy that begins at a starting portion of the channel occupancy; and
receive, from the BS, a downlink transmission in the second portion of the channel occupancy, the downlink transmission comprising at least one of a unicast downlink transmission addressed only to the UE or a non-unicast downlink transmission addressed to a set of UEs including the UE.

2. The UE of claim 1, wherein the transceiver is further configured not to receive another unicast downlink transmission not addressed to the UE.

3. The UE of claim 1, wherein the type of the LBT process comprises at least one of:
a first type of the LBT process including a random duration for a channel sensing;
a second type of the LBT process including a fixed duration of 25 microseconds for the channel sensing;
a third type of the LBT process including a fixed duration of 16 microseconds for the channel sensing; or
a fourth type of the LBT process not including a duration for the channel sensing.

4. The UE of claim 3, wherein:
the processor is further configured to include a gap between the downlink transmission in the second portion of the channel occupancy and the uplink transmission in the first portion of the channel occupancy in the channel occupancy;
an LBT process of the BS is performed in the gap; and
a type of the LBT process is identified based on a duration of the gap.

5. The UE of claim 4, wherein the type of the LBT process comprises at least one of:
the fourth type of the LBT process when the duration of the gap is smaller than 16 microseconds; or
the second or the third type of the LBT process when the duration of the gap is equal to or greater than 16 microseconds.

6. The UE of claim 1, wherein the processor is further configured to identify a value of LBT priority class included in the DCI.

7. The UE of claim 1, wherein:
the transceiver is further configured to receive the DCI including scheduling information for the PUSCH; and
the DCI is a DCI format 0_1.

8. A base station (BS) in a wireless communication system supporting a shared spectrum channel access, the BS comprising:
a processor; and
a transceiver operably connected to the processor, the transceiver configured to:
transmit, to a user equipment (UE), downlink control information (DCI) indicating a type of listen-before-talk (LBT) process for an uplink transmission including a physical uplink shared channel (PUSCH);
receive, from the UE, the uplink transmission including the PUSCH in a first portion of a channel occupancy that begins at a starting portion of the channel occupancy; and
transmit, to the UE, a downlink transmission in a second portion of the channel occupancy, the downlink transmission comprising at least one of a unicast downlink transmission addressed only to the UE or a non-unicast downlink transmission addressed to a set of UEs including the UE,
wherein:
an LBT process of the UE is performed based on the type of the LBT process indicated in the DCI, and
a channel occupancy is initialized by the UE during a channel occupancy time (COT), the channel occupancy comprising the first portion and the second portion that do not overlap each other.

9. The BS of claim 8, wherein the transceiver is further configured not to transmit another unicast downlink transmission not addressed to the UE.

10. The BS of claim 8, wherein the type of the LBT process comprises at least one of:
a first type of the LBT process including a random duration for a channel sensing;
a second type of the LBT process including a fixed duration of 25 microseconds for the channel sensing;
a third type of the LBT process including a fixed duration of 16 microseconds for the channel sensing; or
a fourth type of the LBT process not including a duration for the channel sensing.

11. The BS of claim 10, wherein the processor is configured to:
include a gap between the downlink transmission in the second portion of the channel occupancy and the uplink transmission in the first portion of the channel occupancy in the channel occupancy;
perform an LBT process of the BS in the gap; and
a type of the LBT process is identified based on a duration of the gap.

12. The BS of claim 11, wherein the type of the LBT process comprises at least one of:
the fourth type of the LBT process when the duration of the gap is smaller than 16 microseconds; or
the second or the third type of the LBT process when the duration of the gap is equal to or greater than 16 microseconds.

13. The BS of claim 8, wherein the processor is configured to identify a value of LBT priority class included in the DCI.

14. The BS of claim 8, wherein:
the transceiver is further configured to transmit the DCI including scheduling information for the PUSCH; and
the DCI is a DCI format 0_1.

15. A method of a user equipment (UE) in a wireless communication system supporting a shared spectrum channel access, the method comprising:
receiving, from a base station (BS), downlink control information (DCI) indicating a type of listen-before-talk (LBT) process for an uplink transmission including a physical uplink shared channel (PUSCH);
performing an LBT process based on the type of the LBT process indicated in the DCI;
initializing, during a channel occupancy time (COT), a channel occupancy comprising a first portion and a second portion that do not overlap each other;
transmitting, to the BS, the uplink transmission including the PUSCH in the first portion of the channel occupancy that begins at a starting portion of the channel occupancy; and
receiving, from the BS, a downlink transmission in the second portion of the channel occupancy, the downlink transmission comprising at least one of a unicast downlink transmission addressed only to the UE or a non-unicast downlink transmission addressed to a set of UEs including the UE.

16. The method of claim 15, further comprising not receiving another unicast downlink transmission not addressed to the UE.

17. The method of claim 15, wherein the type of the LBT process comprises at least one of:
a first type of the LBT process including a random duration for a channel sensing;
a second type of the LBT process including a fixed duration of 25 microseconds for the channel sensing;
a third type of the LBT process including a fixed duration of 16 microseconds for the channel sensing; or
a fourth type of the LBT process not including a duration for the channel sensing.

18. The method of claim 17, further comprising including a gap between the downlink transmission in the second portion of the channel occupancy and the uplink transmission in the first portion of the channel occupancy in the channel occupancy,
wherein;
an LBT process of the BS is performed in the gap; and
a type of the LBT process is identified based on a duration of the gap.

19. The method of claim 18, wherein the type of the LBT process comprises at least one of:
the fourth type of the LBT process when the duration of the gap is smaller than 16 microseconds; or
the second or the third type of the LBT process when the duration of the gap is equal to or greater than 16 microseconds.

20. The method of claim 15, further comprising:
identifying a value of LBT priority class included in the DCI; and
receiving the DCI including scheduling information for the PUSCH,
wherein the DCI is a DCI format 0_1.
